(19) United States
(12) Patent Application Publication
(10) Pub. No.: US 2013/0144619 A1
(43) Pub. Date: Jun. 6, 2013

(54) ENHANCED VOICE CONFERENCING

(71) Applicants: Richard T. Lord, Tacoma, WA (US); Robert W. Lord, Seattle, WA (US); Nathan P. Myhrvold, Medina, WA (US); Clarence T. Tegreene, Bellevue, WA (US); Roderick A. Hyde, Redmond, WA (US); Lowell L. Wood, JR., Bellevue, WA (US); Muriel Y. Ishikawa, Livermore, CA (US); Victoria Y.H. Wood, Livermore, CA (US); Charles Whitmer, North Bend, WA (US); Paramvir Bahl, Bellevue, WA (US); Doughlas C. Burger, Bellevue, WA (US); Ranveer Chandra, Kirkland, WA (US); William H. Gates, III, Medina, WA (US); Paul Holman, Seattle, WA (US); Jordin T. Kare, Seattle, WA (US); Craig J. Mundie, Seattle, WA (US); Tim Paek, Sammamish, WA (US); Desney S. Tan, Kirkland, WA (US); Lin Zhong, Houston, TX (US); Matthew G. Dyor, Bellevue, WA (US)

(72) Inventors: Richard T. Lord, Tacoma, WA (US); Robert W. Lord, Seattle, WA (US); Nathan P. Myhrvold, Medina, WA (US); Clarence T. Tegreene, Bellevue, WA (US); Roderick A. Hyde, Redmond, WA (US); Lowell L. Wood, JR., Bellevue, WA (US); Muriel Y. Ishikawa, Livermore, CA (US); Victoria Y.H. Wood, Livermore, CA (US); Charles Whitmer, North Bend, WA (US); Paramvir Bahl, Bellevue, WA (US); Doughlas C. Burger, Bellevue, WA (US); Ranveer Chandra, Kirkland, WA (US); William H. Gates, III, Medina, WA (US); Paul Holman, Seattle, WA (US); Jordin T. Kare, Seattle, WA (US); Craig J. Mundie, Seattle, WA (US); Tim Paek, Sammamish, WA (US); Desney S. Tan, Kirkland, WA (US); Lin Zhong, Houston, TX (US); Matthew G. Dyor, Bellevue, WA (US)

(21) Appl. No.: 13/356,419

(22) Filed: Jan. 23, 2012

Related U.S. Application Data
(63) Continuation-in-part of application No. 13/309,248, filed on Dec. 1, 2011.
Application No. 13/309,248 is a continuation-in-part of application No. 13/324,232, filed on Dec. 13, 2011.
Application No. 13/324,232 is a continuation-in-part of application No. 13/340,143, filed on Dec. 29, 2011.

(51) Int. Cl. G10L 15/26; G10L 15/00; G10L 17/00

(52) U.S. Cl. 704/235; 704/246; 704/249; 704/E17.003; 704/E17.004; 704/E15.043

(57) ABSTRACT

Techniques for ability enhancement are described. Some embodiments provide an ability enhancement facilitator system (“AEFS”) configured to enhance voice conferencing among multiple speakers. In one embodiment, the AEFS receives data that represents utterances of multiple speakers who are engaging in a voice conference with one another. The AEFS then determines speaker-related information, such as by identifying a current speaker, locating an information item (e.g., an email message, document) associated with the speaker, or the like. The AEFS then informs a user of the speaker-related information, such as by presenting the speaker-related information on a display of a conferencing device associated with the user.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 13/309,248, entitled AUDIBLE ASSISTANCE, filed 1 Dec. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/324,232, entitled VISUAL PRESENTATION OF SPEAKER-RELATED INFORMATION, filed 13 Dec. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/340,143, entitled LANGUAGE TRANSLATION BASED ON SPEAKER-RELATED INFORMATION, filed 29 Dec. 2011, which is currently co-pending, or is an application of which a currently co-pending application is entitled to the benefit of the filing date.

### TECHNICAL FIELD

The present disclosure relates to methods, techniques, and systems for ability enhancement and, more particularly, to methods, techniques, and systems for voice conferencing enhanced by using speaker-related information determined from speaker utterances and/or other sources.

### BACKGROUND

Human abilities such as hearing, vision, memory, foreign or native language comprehension, and the like may be limited for various reasons. For example, with aging, various abilities such as hearing, vision, memory, may decline or otherwise become compromised. As the population in general ages, such declines may become more common and widespread. In addition, young people are increasingly listening to music through headphones, which may also result in hearing loss at earlier ages.

In addition, limits on human abilities may be exposed by factors other than aging, injury, or overuse. As one example, the world population is faced with an ever increasing amount of information to review, remember, and/or integrate. Managing increasing amounts of information becomes increasingly difficult in the face of limited or declining abilities such as hearing, vision, and memory. As another example, as the world becomes increasingly virtually and physically connected (e.g., due to improved communication and cheaper travel), people are more frequently encountering others who speak different languages. In addition, the communication technologies that support an interconnected, global economy may further expose limited human abilities. For example, it may be difficult for a user to determine who is speaking during a conference call. Even if the user is able to identify the speaker, it may still be difficult for the user to recall or access related information about the speaker and/or topics discussed during the call.

Current approaches to addressing limits on human abilities may suffer from various drawbacks. For example, there may be a social stigma connected with wearing hearing aids, corrective lenses, or similar devices. In addition, hearing aids typically perform only limited functions, such as amplifying or modulating sounds for a hearer. As another example, current approaches to foreign language translation, such as phrase books or time-intensive language acquisition, are typically inefficient and/or unwieldy. Furthermore, existing communication technologies are not well integrated with one another, making it difficult to access information via a first device that is relevant to a conversation occurring via a second device.

### BRIEF DESCRIPTION OF THE DRAWINGS

FIG. 1A is an example block diagram of an ability enhancement facilitator system according to an example embodiment.

FIG. 1B is an example block diagram illustrating various conferencing devices according to example embodiments.

FIG. 2 is an example functional block diagram of an example ability enhancement facilitator system according to an example embodiment.

FIGS. 3.1-3.108 are example flow diagrams of ability enhancement processes performed by example embodiments.

FIG. 4 is an example block diagram of an example computing system for implementing an ability enhancement facilitator system according to an example embodiment.

### DETAILED DESCRIPTION

Embodiments described herein provide enhanced computer- and network-based methods and systems for enhanced voice conferencing and, more particularly, for voice conferencing enhanced by presenting speaker-related information determined at least in part on speaker utterances. Example embodiments provide an Ability Enhancement Facilitator System (“AEFS”). The AEFS may augment, enhance, or improve the senses (e.g., hearing), faculties (e.g., memory, language comprehension), and/or other abilities of a user, such as by determining and presenting speaker-related information to participants in a conference call. For example, when multiple speakers engage in a voice conference (e.g., a telephone conference), the AEFS may “listen” to the voice conference in order to determine speaker-related information, such as identifying information (e.g., name, title) about the current speaker (or some other speaker) and/or events/communications relating to the current speaker and/or to the subject matter of the conference call generally. Then, the AEFS may inform a user (typically one of the participants in the voice conference) of the determined information, such as by presenting the information via a conferencing device (e.g., smart phone, laptop, desktop telephone) associated with the user. The user can then receive the information (e.g., by reading or hearing it via the conferencing device) provided by the AEFS and advantageously use that information to avoid embarrassment (e.g., due to an inability to identify the speaker), engage in a more productive conversation (e.g., by quickly accessing information about events, deadlines, or communications related to the speaker), or the like.

In some embodiments, the AEFS is configured to receive data that represents speech signals from a voice conference amongst multiple speakers. The multiple speakers may be remotely located from one another, such as by being in different rooms within a building, by being in different buildings within a site or campus, by being in different cities, or the like. Typically, the multiple speakers are each using a conferencing device, such as a land-line telephone, cell phone, smart phone, computer, or the like, to communicate with one another. The AEFS may obtain the data that represents the speech signals from one or more of the conferencing devices and/or from some intermediary point, such as a conference call facility, chat system, videoconferencing system, PBX, or the like. The AEFS may then determine voice conference-related information, including speaker-related information associated with the one or more of the speakers. Determining speaker-related information may include identifying the speaker based at least in part on the received data, such as by performing speaker recognition and/or speech recognition with the received data. Determining speaker-related information may also or instead include determining an identifier (e.g., name or title) of the speaker, an information item (e.g., a document, event, communication) that references the speaker, or the like. Then, the AEFS may inform a user of the determined speaker-related information by, for example, visually presenting the speaker-related information via a display screen of a conferencing device associated with the user. In other embodiments, some other display may be used, such as a screen on a laptop computer that is being used by the user while the user is engaged in the voice conference via a telephone. In some embodiments, the AEFS may inform the user in an audible manner, such as by “speaking” the determined speaker-related information via an audio speaker of the conferencing device.

In some embodiments, the AEFS may perform other services, including translating utterances made by speakers in a voice conference, so that a multi-lingual voice conference may be facilitated even when some speakers do not understand the language used by other speakers. In such cases, the determined speaker-related information may be used to enhance or augment language translation and/or related processes, including speech recognition, natural language processing, and the like.

### 1. Ability Enhancement Facilitator System Overview

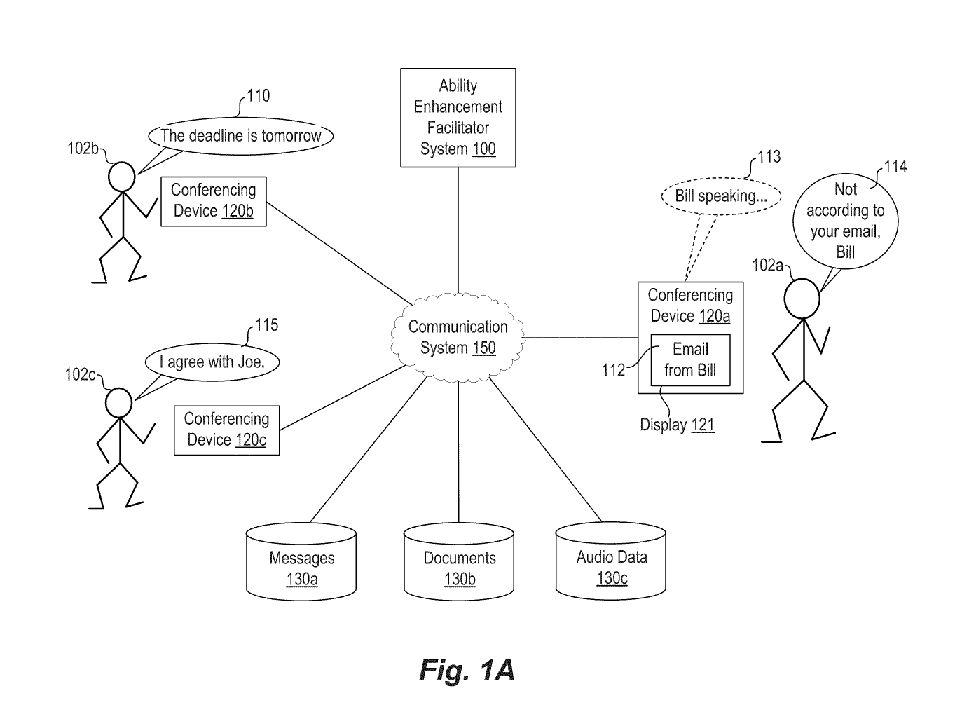

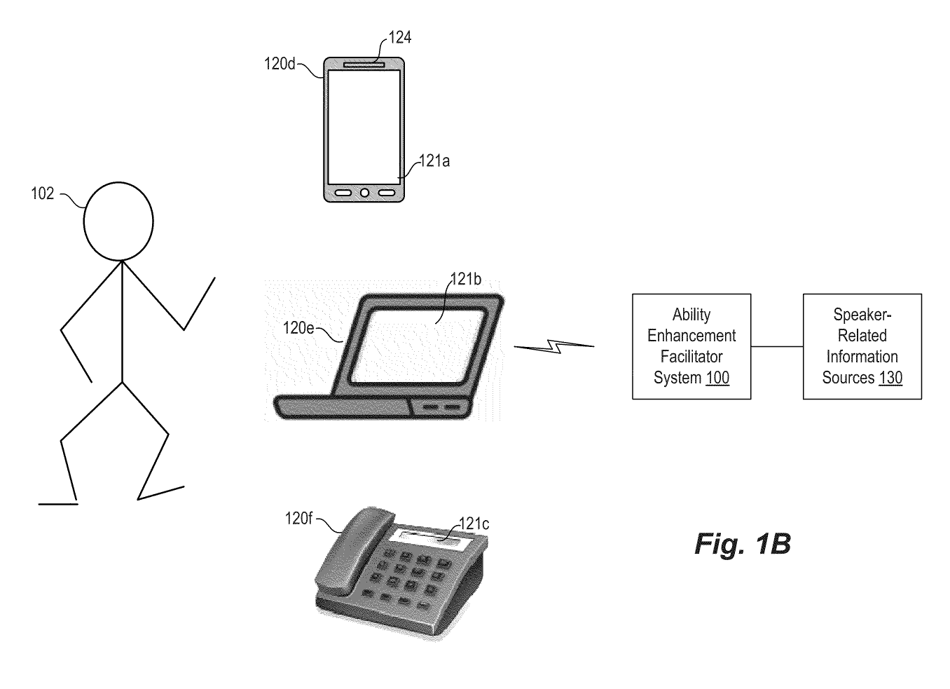

FIG. 1A is an example block diagram of an ability enhancement facilitator system according to an example embodiment. In particular, FIG. 1A shows multiple speakers 102a-102c engaging in a voice conference with one another. In particular, a first speaker 102a (who may also be referred to as a “user”) is engaging in a voice conference with speakers 102b and 102c. Abilities of the speaker 102a are being enhanced, via a conferencing device 120a, by an Ability Enhancement Facilitator System (“AEFS”) 100. The conferencing device 120a includes a display 121 that is configured to present text and/or graphics. The conferencing device 120a also includes an audio speaker (not shown) that is configured to present audio output. Speakers 102b and 102c are each respectively using a conferencing device 120b and 120c to engage in the voice conference with each other and speaker 102a via a communication system 150.

The AEFS 100 and the conferencing devices 120 are communicatively coupled to one another via the communication system 150. The AEFS 100 is also communicatively coupled to speaker-related information sources 130, including messages 130a, documents 130b, and audio data 130c. The AEFS 100 uses the information in the information sources 130, in conjunction with data received from the conferencing devices 120, to determine information related to the voice conference, including speaker-related information associated with the speakers 102.

In the scenario illustrated in FIG. 1A, the voice conference among the speakers 102 is underway. For this example, participants in the voice conference are attempting to determine the date of a particular deadline for a project. The speaker 102b believes that the deadline is tomorrow, and has made an utterance 110 by speaking the words “The deadline is tomorrow.” The speaker 102a may have a notion or belief that the speaker 102b is incorrect, but may not be able to support such an assertion. As will be discussed further below, the AEFS 100 will assist user 102a in determining that the deadline is actually next week, not tomorrow.

The AEFS 100 receives data representing a speech signal that represents the utterance 110, such as by receiving a digital representation of an audio signal transmitted by conferencing device 120b. The data representing the speech signal may include audio samples (e.g., raw audio data), compressed audio data, speech vectors (e.g., mel frequency cepstral coefficients), and/or any other data that may be used to represent an audio signal. The AEFS 100 may receive the data in various ways, including from one or more of the conferencing devices or from some intermediate system (e.g., a voice conferencing system that is facilitating the conference between the conferencing devices 120).

The AEFS 100 then determines speaker-related information associated with the speaker 102b. Determining speaker-related information may include identifying the speaker 102b based on the received data representing the speech signal. In some embodiments, identifying the speaker may include performing speaker recognition, such as by generating a “voice print” from the received data and comparing the generated voice print to previously obtained voice prints. For example, the generated voice print may be compared to multiple voice prints that are stored as audio data 130c and that each correspond to a speaker, in order to determine a speaker who has a voice that most closely matches the voice of the speaker 102b. The voice prints stored as audio data 130c may be generated based on various sources of data, including data corresponding to speakers previously identified by the AEFS 100, voice mail messages, speaker enrollment data, or the like.

In some embodiments, identifying the speaker 102b may include performing speech recognition, such as by automatically converting the received data representing the speech signal into text. The text of the speaker's utterance may then be used to identify the speaker 102b. In particular, the text may identify one or more entities such as information items (e.g., communications, documents), events (e.g., meetings, deadlines), persons, or the like, that may be used by the AEFS 100 to identify the speaker 102b. The information items may be accessed with reference to the messages 130a and/or documents 130b. As one example, the speaker's utterance 110 may identify an email message that was sent to the speaker 102b and possibly others (e.g., “That sure was a nasty email Bob sent”). As another example, the speaker's utterance 110 may identify a meeting or other event to which the speaker 102b and possibly others are invited.

Note that in some cases, the text of the speaker's utterance 110 may not definitively identify the speaker 102b, such as because the speaker 102b has not previously met or communicated with other participants in the voice conference or because a communication was sent to recipients in addition to the speaker 102b. In such cases, there may be some ambiguity as to the identity of the speaker 102b. However, in such cases, a preliminary identification of multiple candidate speakers may still be used by the AEFS 100 to narrow the set of potential speakers, and may be combined with (or used to improve) other techniques, including speaker recognition as discussed above. In addition, even if the speaker 102 is unknown to the user 102a the AEFS 100 may still determine useful demographic or other speaker-related information that may be fruitfully employed for speech recognition or other purposes.

Note also that speaker-related information need not definitively identify the speaker. In particular, it may also or instead be or include other information about or related to the speaker, such as demographic information including the gender of the speaker 102, his country or region of origin, the language(s) spoken by the speaker 102, or the like. Speaker-related information may include an organization that includes the speaker (along with possibly other persons, such as a company or firm), an information item that references the speaker (and possibly other persons), an event involving the speaker, or the like. The speaker-related information may generally be determined with reference to the messages 130a, documents 130b, and/or audio data 130c. For example, having determined the identity of the speaker 102, the AEFS 100 may search for emails and/or documents that are stored as messages 130a and/or documents 103b and that reference (e.g., are sent to, are authored by, are named in) the speaker 102.

Other types of speaker-related information is contemplated, including social networking information, such as personal or professional relationship graphs represented by a social networking service, messages or status updates sent within a social network, or the like. Social networking information may also be derived from other sources, including email lists, contact lists, communication patterns (e.g., frequent recipients of emails), or the like.

The AEFS 100 then informs the user (speaker 102a) of the determined speaker-related information. Informing the user may include audibly presenting the information to the user via an audio speaker of the conferencing device 120a. In this example, the conferencing device 120a tells the user, such as by playing audio via an earpiece or in another manner that cannot be detected by the other participants in the voice conference, that speaker 102b is currently speaking. In particular, the conferencing device 120a plays audio that includes the utterance “Bill speaking” to the user.

Informing the user of the determined speaker-related information may also or instead include visually presenting the information, such as via the display 121 or audio speaker of conferencing device 120a. In the illustrated example, the AEFS 100 causes a message 112 that includes text of an email from Bill (speaker 102b) to be displayed on the display 121. In this example, the displayed email includes a statement from Bill (speaker 102b) that sets the project deadline to next week, not tomorrow. Upon reading the message 112 and thereby learning the actual project deadline, the speaker 102a responds to the original utterance 110 of speaker 102b (Bill) with a response utterance 114 that includes the words “Not according to your email, Bill.” In the illustrated example, speaker 102c, upon hearing the utterance 114, responds with an utterance 115 that includes the words “I agree with Joe,” indicating his agreement with speaker 102a.

As the speakers 102a-102c continue to engage in the voice conference, the AEFS 100 may monitor the conversation and continue to determine and present speaker-related information at least to the speaker 102a. Another example function that may be performed by the AEFS 100 includes presenting, as each of the multiple speakers takes a turn speaking during the voice conference, information about the identity of the current speaker. For example, in response to the onset of an utterance of a speaker, the AEFS 100 may display the name of the speaker on the display 121, so that the user is always informed as to who is speaking.

The AEFS 100 may perform other services, including translating utterances made by speakers in the voice conference, so that a multi-lingual voice conference may be conducted even between participants who do not understand all of the languages being spoken. Translating utterances may initially include determining speaker-related information by automatically determining the language that is being used by a current speaker. Determining the language may be based on signal processing techniques that identify signal characteristics unique to particular languages. Determining the language may also or instead be performed by simultaneous or concurrent application of multiple speech recognizers that are each configured to recognize speech in a corresponding language, and then choosing the language corresponding to the recognizer that produces the result having the highest confidence level. Determining the language may also or instead be based on contextual factors, such as GPS information indicating that the current speaker is in Germany, Austria, or some other region where German is commonly spoken.

Having determined speaker-related information, the AEFS 100 may then translate an utterance in a first language into an utterance in a second language. In some embodiments, the AEFS 100 translates an utterance by first performing speech recognition to translate the utterance into a textual representation that includes a sequence of words in the first language. Then, the AEFS 100 may translate the text in the first language into a message in a second language, using machine translation techniques. Speech recognition and/or machine translation may be modified, enhanced, and/or otherwise adapted based on the speaker-related information. For example, a speech recognizer may use speech or language models tailored to the speaker's gender, accent/dialect (e.g., determined based on country/region of origin), social class, or the like. As another example, a lexicon that is specific to the speaker may be used during speech recognition and/or language translation. Such a lexicon may be determined based on prior communications of the speaker, profession of the speaker (e.g., engineer, attorney, doctor), or the like.

Once the AEFS 100 has translated an utterance in a first language into a message in a second language, the AEFS 100 can present the message in the second language. Various techniques are contemplated. In one approach, the AEFS 100 causes the conferencing device 120a (or some other device accessible to the user) to visually display the message on the display 121. In another approach, the AEFS 100 causes the conferencing device 120a (or some other device) to “speak” or “tell” the user/speaker 102a the message in the second language. Presenting a message in this manner may include converting a textual representation of the message into audio via text-to-speech processing (e.g., speech synthesis), and then presenting the audio via an audio speaker (e.g., earphone, earpiece, earbud) of the conferencing device 120a.

FIG. 1B is an example block diagram illustrating various conferencing devices according to example embodiments. In particular, FIG. 1B illustrates an AEFS 100 in communication with example conferencing devices 120d-120f. Conferencing device 120d is a smart phone that includes a display 121a and an audio speaker 124. Conferencing device 120e is a laptop computer that includes a display 121b. Conferencing device 120f is an office telephone that includes a display 121c. Each of the illustrated conferencing devices 120 includes or may be communicatively coupled to a microphone operable to receive a speech signal from a speaker. As described above, the conferencing device 120 may then convert the speech signal into data representing the speech signal, and then forward the data to the AEFS 100.

As an initial matter, note that the AEFS 100 may use output devices of a conferencing device or other devices to present information to a user, such as speaker-related information that may generally assist the user in engaging in a voice conference with other participants. For example, the AEFS 100 may present speaker-related information about a current speaker, such as his name, title, communications that reference or are related to the speaker, and the like.

For audio output, each of the illustrated conferencing devices 120 may include or be communicatively coupled to an audio speaker operable to generate and output audio signals that may be perceived by the user 102. As discussed above, the AEFS 100 may use such a speaker to provide speaker-related information to the user 102. The AEFS 100 may also or instead audibly notify, via a speaker of a conferencing device 120, the user 102 to view speaker-related information displayed on the conferencing device 120. For example, the AEFS 100 may cause a tone (e.g., beep, chime) to be played via the earpiece of the telephone 120f. Such a tone may then be recognized by the user 102, who will in response attend to information displayed on the display 121c. Such audible notification may be used to identify a display that is being used as a current display, such as when multiple displays are being used. For example, different first and second tones may be used to direct the user's attention to the smart phone display 121a and laptop display 121b, respectively. In some embodiments, audible notification may include playing synthesized speech (e.g., from text-to-speech processing) telling the user 102 to view speaker-related information on a particular display device (e.g., “Recent email on your smart phone”).

The AEFS 100 may generally cause speaker-related information (or other information including translations) to be presented on various destination output devices. In some embodiments, the AEFS 100 may use a display of a conferencing device as a target for displaying information. For example, the AEFS 100 may display speaker-related information on the display 121a of the smart phone 120d. On the other hand, when the conferencing device does not have its own display or if the display is not suitable for displaying the determined information, the AEFS 100 may display speaker-related information on some other destination display that is accessible to the user 102. For example, when the telephone 120f is the conferencing device and the user also has the laptop computer 120e in his possession, the AEFS 100 may elect to display an email or other substantial document upon the display 121b of the laptop computer 120e.

The AEFS 100 may determine a destination output device for a translation, speaker-related information, or other information. In some embodiments, determining a destination output device may include selecting from one of multiple possible destination displays based on whether a display is capable of displaying all of the information. For example, if the environment is noisy, the AEFS may elect to visually display a translation rather than play it through a speaker. As another example, if the user 102 is proximate to a first display that is capable of displaying only text and a second display capable of displaying graphics, the AEFS 100 may select the second display when the presented information includes graphics content (e.g., an image). In some embodiments, determining a destination display may include selecting from one of multiple possible destination displays based on the size of each display. For example, a small LCD display (such as may be found on a mobile phone or telephone 120f) may be suitable for displaying a message that is just a few characters (e.g., a name or greeting) but not be suitable for displaying longer message or large document. Note that the AEFS 100 may select among multiple potential target output devices even when the conferencing device itself includes its own display and/or speaker.

Determining a destination output device may be based on other or additional factors. In some embodiments, the AEFS 100 may use user preferences that have been inferred (e.g., based on current or prior interactions with the user 102) and/or explicitly provided by the user. For example, the AEFS 100 may determine to present a translation, an email, or other speaker-related information onto the display 121a of the smart phone 120d based on the fact that the user 102 is currently interacting with the smart phone 120d.

Note that although the AEFS 100 is shown as being separate from a conferencing device 120, some or all of the functions of the AEFS 100 may be performed within or by the conferencing device 120 itself. For example, the smart phone conferencing device 120d and/or the laptop computer conferencing device 120e may have sufficient processing power to perform all or some functions of the AEFS 100, including one or more of speaker identification, determining speaker-related information, speaker recognition, speech recognition, language translation, presenting information, or the like. In some embodiments, the conferencing device 120 includes logic to determine where to perform various processing tasks, so as to advantageously distribute processing between available resources, including that of the conferencing device 120, other nearby devices (e.g., a laptop or other computing device of the user 102), remote devices (e.g., “cloud-based” processing and/or storage), and the like.

Other types of conferencing devices and/or organizations are contemplated. In some embodiments, the conferencing device may be a “thin” device, in that it may serve primarily as an output device for the AEFS 100. For example, an analog telephone may still serve as a conferencing device, with the AEFS 100 presenting speaker-related information via the earpiece of the telephone. As another example, a conferencing device may be or be part of a desktop computer, PDA, tablet computer, or the like.

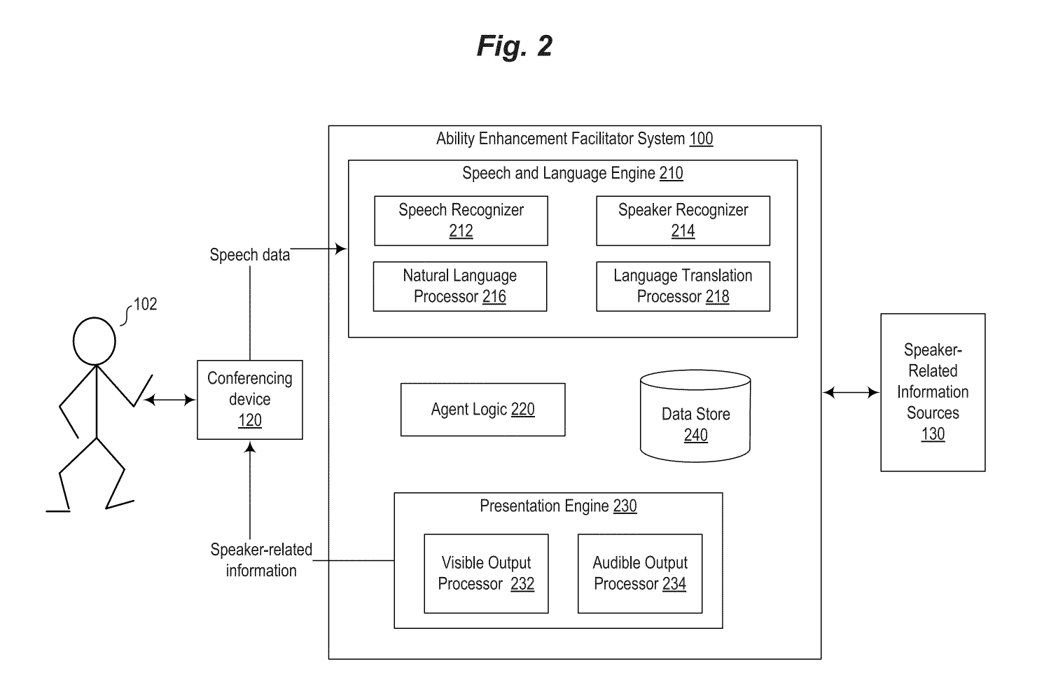

FIG. 2 is an example functional block diagram of an example ability enhancement facilitator system according to an example embodiment. In the illustrated embodiment of FIG. 2, the AEFS 100 includes a speech and language engine 210, agent logic 220, a presentation engine 230, and a data store 240.

The speech and language engine 210 includes a speech recognizer 212, a speaker recognizer 214, a natural language processor 216, and a language translation processor 218. The speech recognizer 212 transforms speech audio data received (e.g., from the conferencing device 120) into textual representation of an utterance represented by the speech audio data. In some embodiments, the performance of the speech recognizer 212 may be improved or augmented by use of a language model (e.g., representing likelihoods of transitions between words, such as based on n-grams) or speech model (e.g., representing acoustic properties of a speaker's voice) that is tailored to or based on an identified speaker. For example, once a speaker has been identified, the speech recognizer 212 may use a language model that was previously generated based on a corpus of communications and other information items authored by the identified speaker. A speaker-specific language model may be generated based on a corpus of documents and/or messages authored by a speaker. Speaker-specific speech models may be used to account for accents or channel properties (e.g., due to environmental factors or communication equipment) that are specific to a particular speaker, and may be generated based on a corpus of recorded speech from the speaker. In some embodiments, multiple speech recognizers are present, each one configured to recognize speech in a different language.

The speaker recognizer 214 identifies the speaker based on acoustic properties of the speaker's voice, as reflected by the speech data received from the conferencing device 120. The speaker recognizer 214 may compare a speaker voice print to previously generated and recorded voice prints stored in the data store 240 in order to find a best or likely match. Voice prints or other signal properties may be determined with reference to voice mail messages, voice chat data, or some other corpus of speech data.

The natural language processor 216 processes text generated by the speech recognizer 212 and/or located in information items obtained from the speaker-related information sources 130. In doing so, the natural language processor 216 may identify relationships, events, or entities (e.g., people, places, things) that may facilitate speaker identification, language translation, and/or other functions of the AEFS 100. For example, the natural language processor 216 may process status updates posted by the user 102a on a social networking service, to determine that the user 102a recently attended a conference in a particular city, and this fact may be used to identify a speaker and/or determine other speaker-related information, which may in turn be used for language translation or other functions.

The language translation processor 218 translates from one language to another, for example, by converting text in a first language to text in a second language. The text input to the language translation processor 218 may be obtained from, for example, the speech recognizer 212 and/or the natural language processor 216. The language translation processor 218 may use speaker-related information to improve or adapt its performance. For example, the language translation processor 218 may use a lexicon or vocabulary that is tailored to the speaker, such as may be based on the speaker's country/region of origin, the speaker's social class, the speaker's profession, or the like.

The agent logic 220 implements the core intelligence of the AEFS 100. The agent logic 220 may include a reasoning engine (e.g., a rules engine, decision trees, Bayesian inference engine) that combines information from multiple sources to identify speakers, determine speaker-related information, and the like. For example, the agent logic 220 may combine spoken text from the speech recognizer 212, a set of potentially matching (candidate) speakers from the speaker recognizer 214, and information items from the information sources 130, in order to determine a most likely identity of the current speaker. As another example, the agent logic 220 may identify the language spoken by the speaker by analyzing the output of multiple speech recognizers that are each configured to recognize speech in a different language, to identify the language of the speech recognizer that returns the highest confidence result as the spoken language.

The presentation engine 230 includes a visible output processor 232 and an audible output processor 234. The visible output processor 232 may prepare, format, and/or cause information to be displayed on a display device, such as a display of the conferencing device 120 or some other display (e.g., a desktop or laptop display in proximity to the user 102a). The agent logic 220 may use or invoke the visible output processor 232 to prepare and display information, such as by formatting or otherwise modifying a translation or some speaker-related information to fit on a particular type or size of display. The audible output processor 234 may include or use other components for generating audible output, such as tones, sounds, voices, or the like. In some embodiments, the agent logic 220 may use or invoke the audible output processor 234 in order to convert a textual message (e.g., including or referencing speaker-related information) into audio output suitable for presentation via the conferencing device 120, for example by employing a text-to-speech processor.

Note that although speaker identification and/or determining speaker-related information is herein sometimes described as including the positive identification of a single speaker, it may instead or also include determining likelihoods that each of one or more persons is the current speaker. For example, the speaker recognizer 214 may provide to the agent logic 220 indications of multiple candidate speakers, each having a corresponding likelihood or confidence level. The agent logic 220 may then select the most likely candidate based on the likelihoods alone or in combination with other information, such as that provided by the speech recognizer 212, natural language processor 216, speaker-related information sources 130, or the like. In some cases, such as when there are a small number of reasonably likely candidate speakers, the agent logic 220 may inform the user 102a of the identities all of the candidate speakers (as opposed to a single speaker) candidate speaker, as such information may be sufficient to trigger the user's recall and enable the user to make a selection that informs the agent logic 220 of the speaker's identity.

Note that in some embodiments, one or more of the illustrated components, or components of different types, may be included or excluded. For example, in one embodiment, the AEFS 100 does not include the language translation processor 218.

### 2. Example Processes

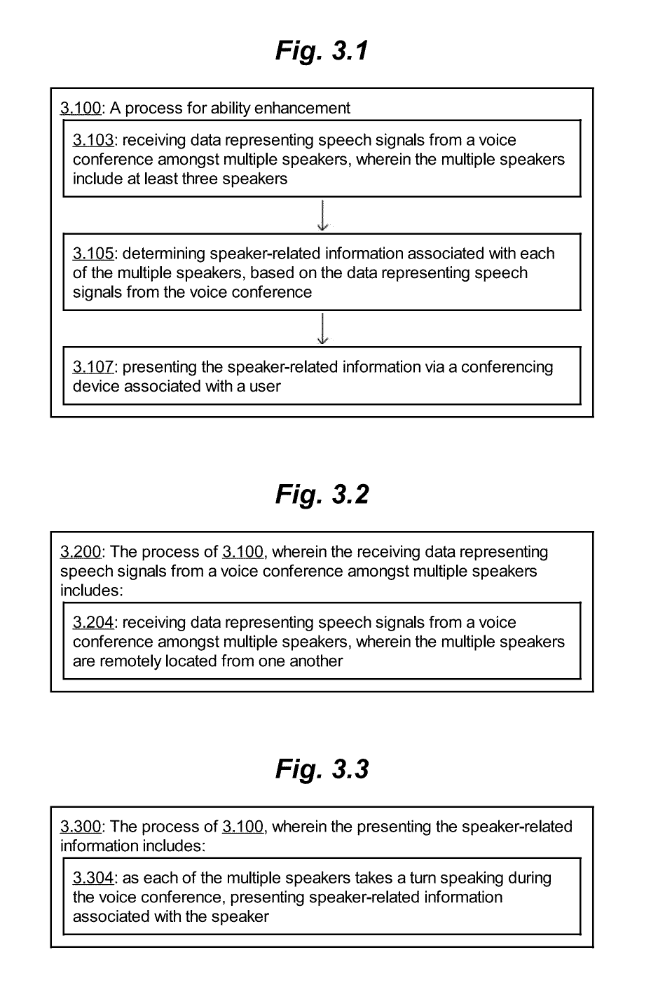

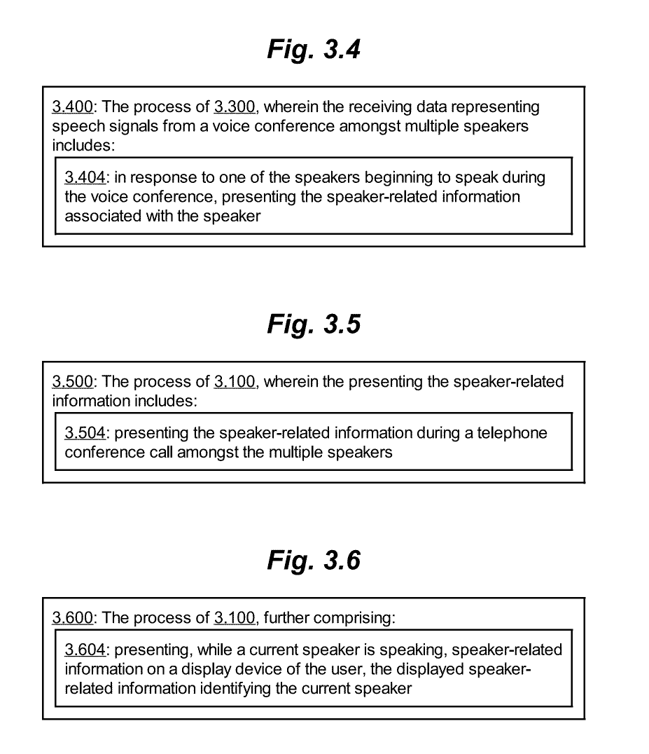

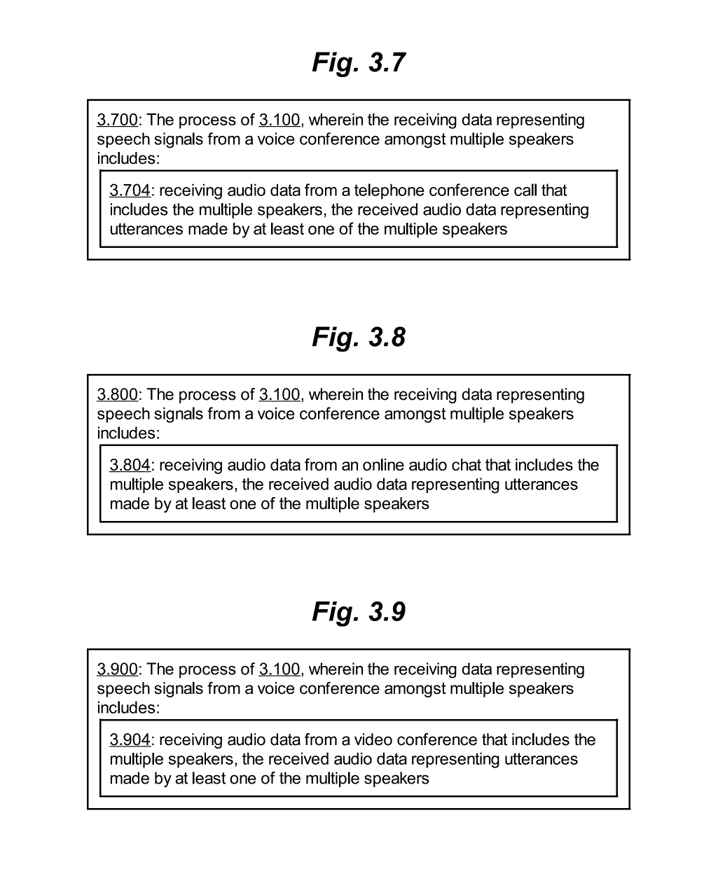

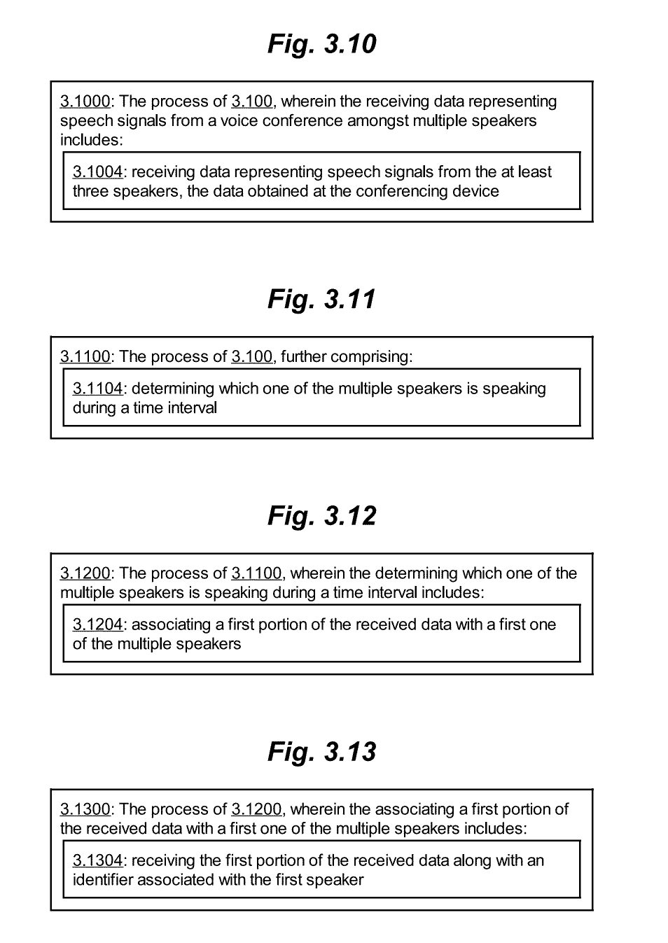

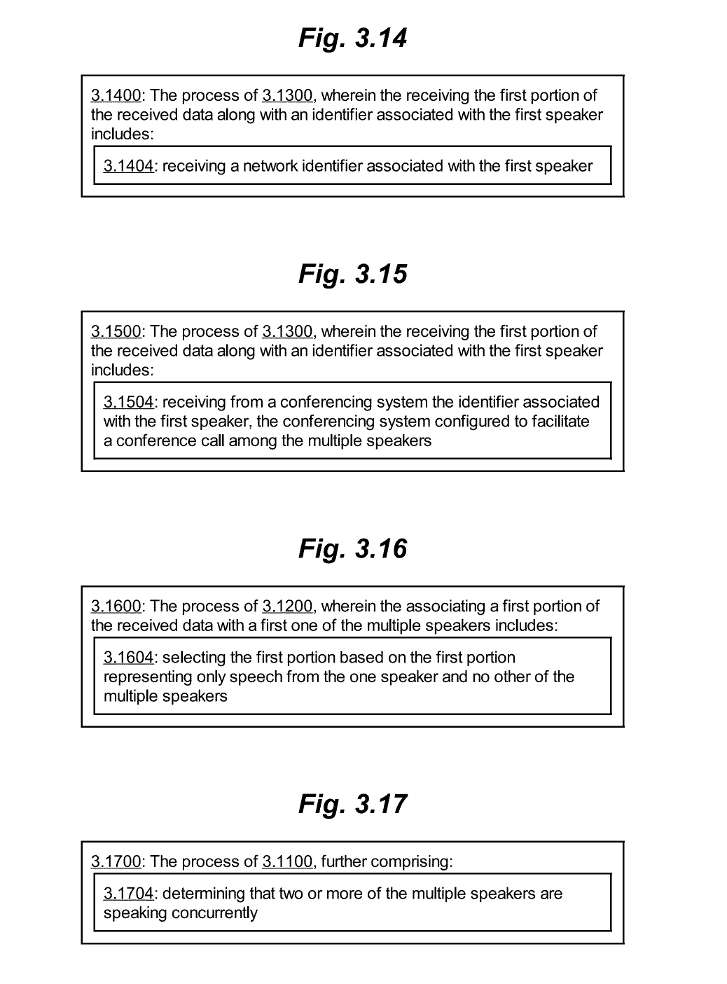

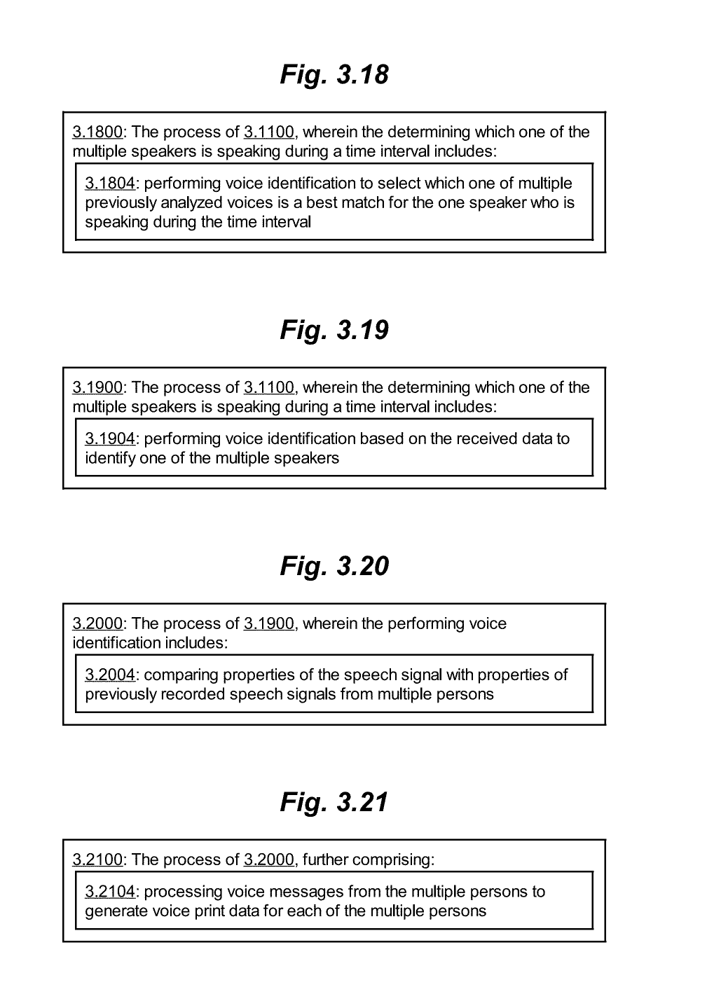

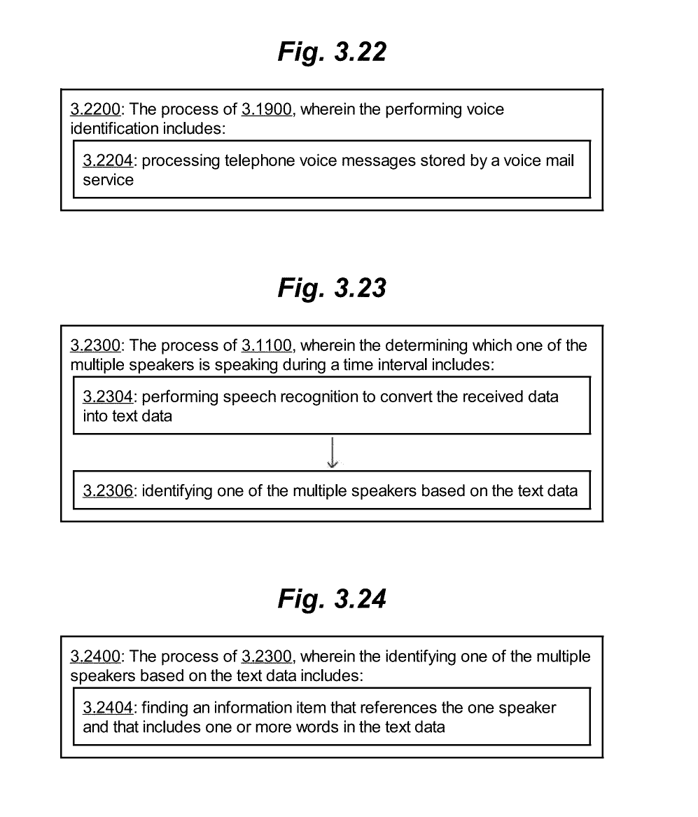

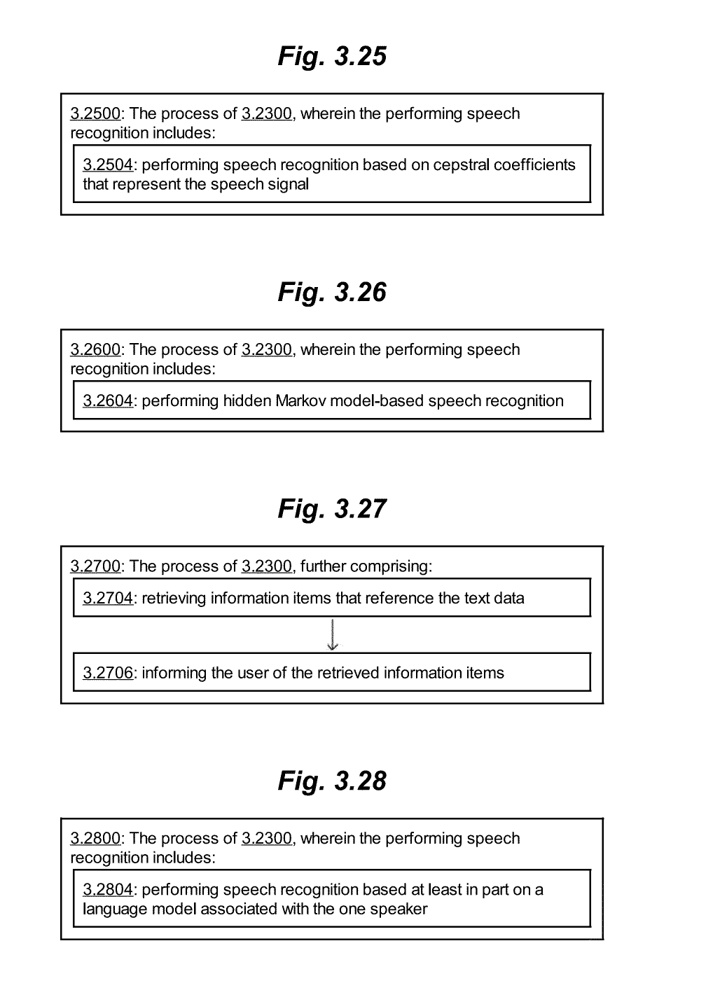

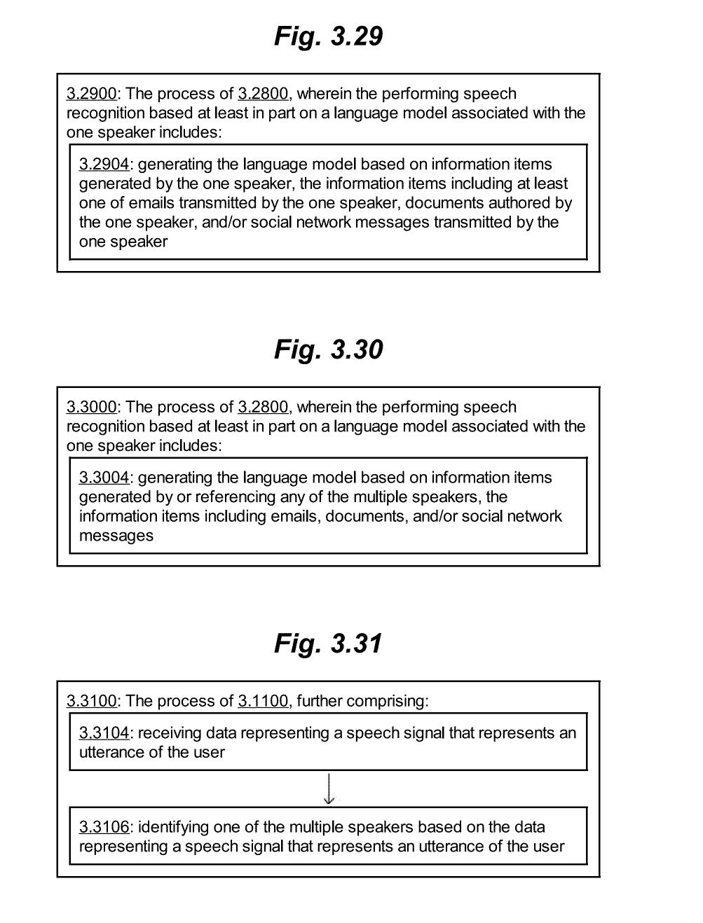

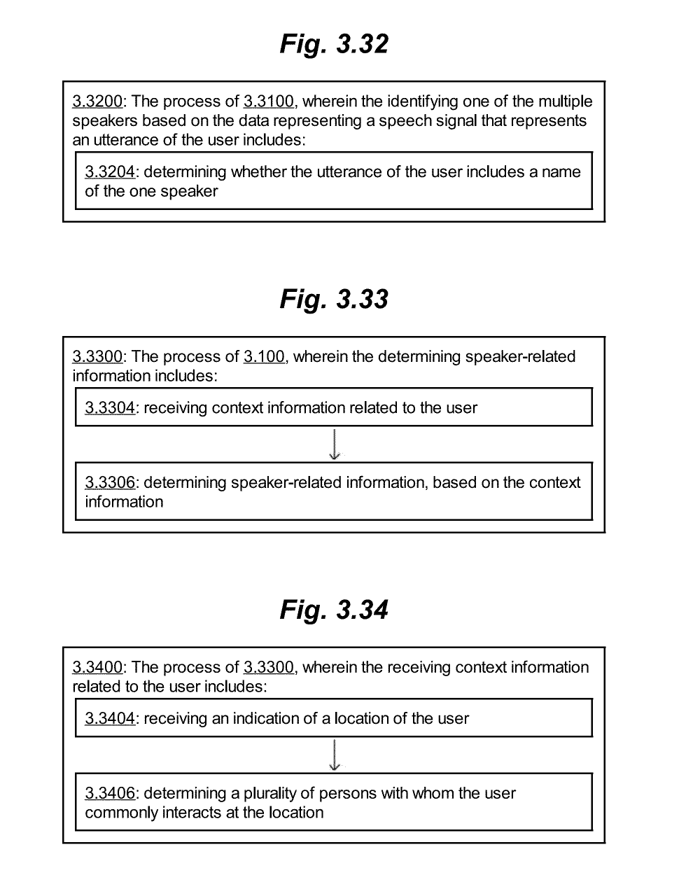

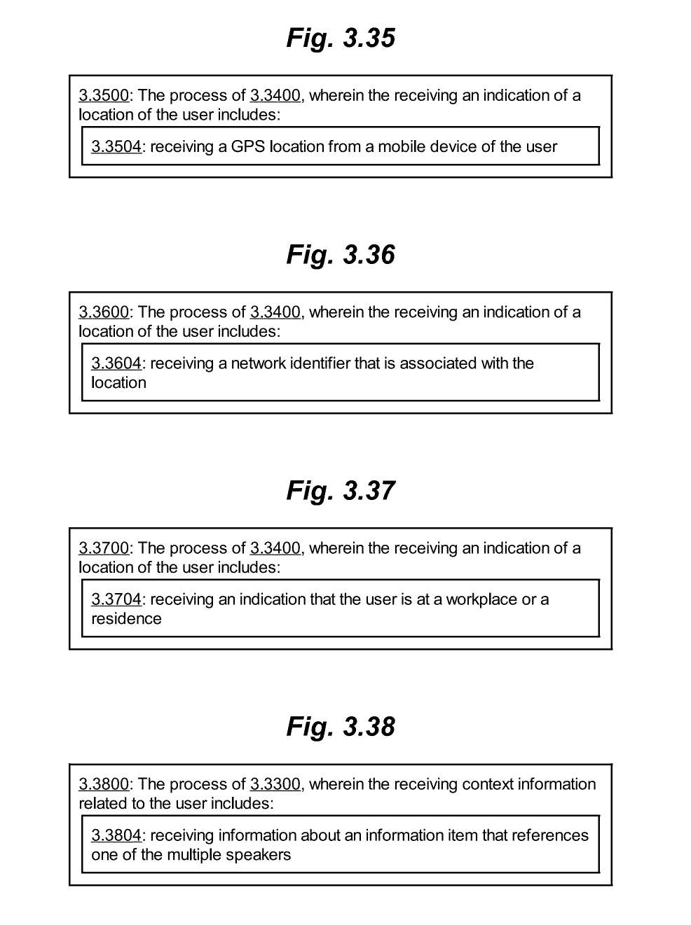

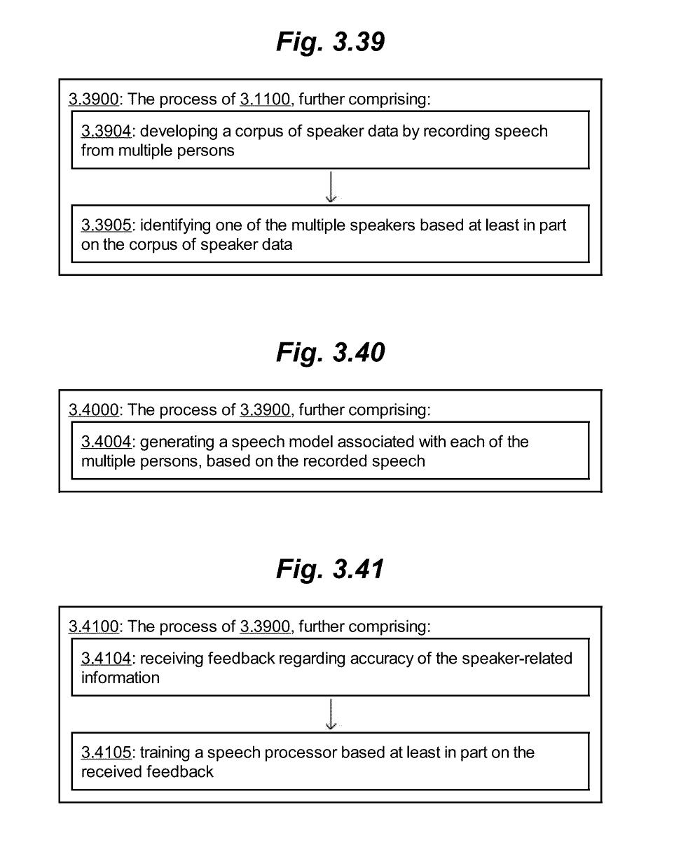

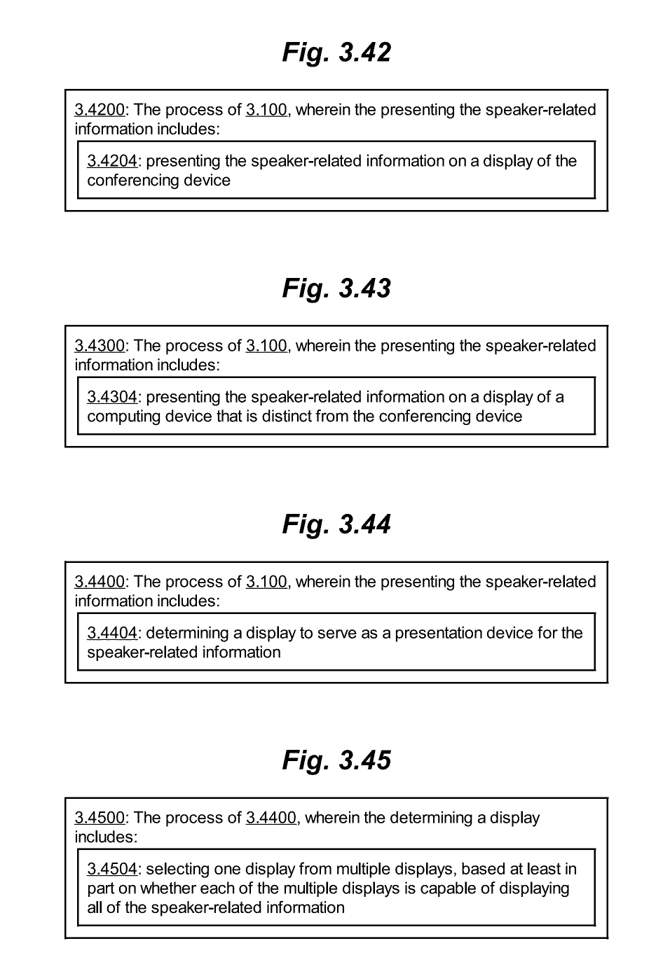

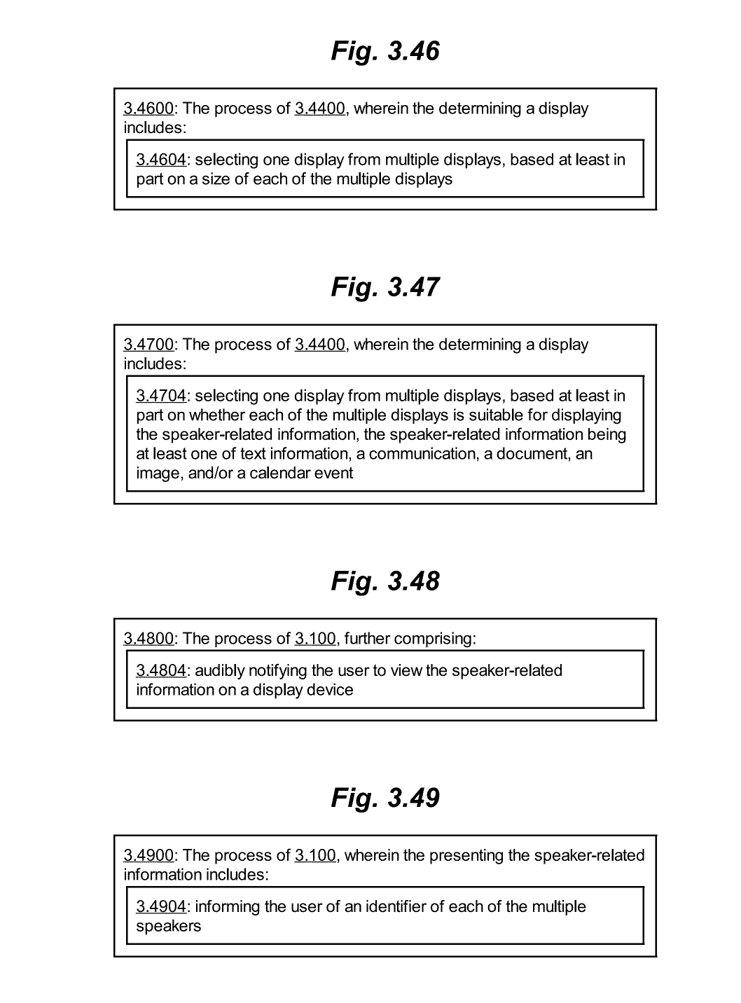

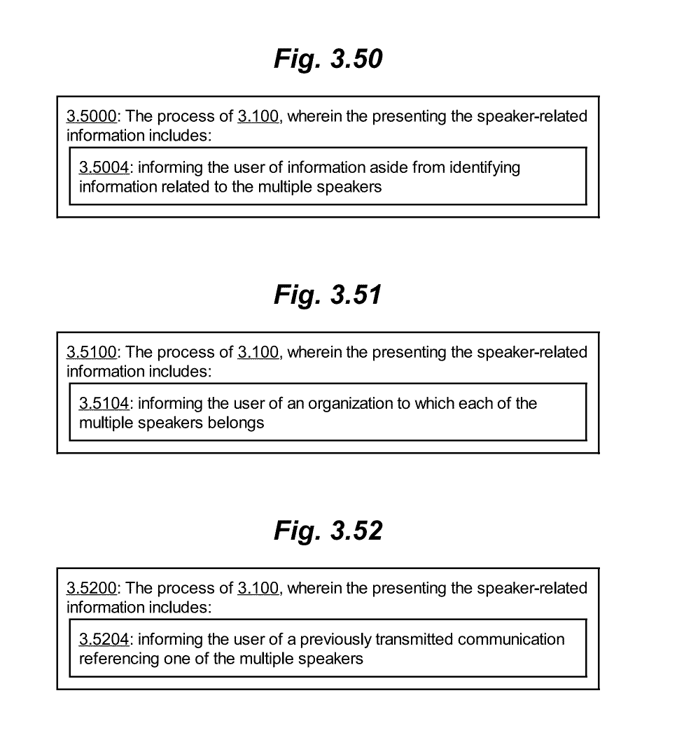

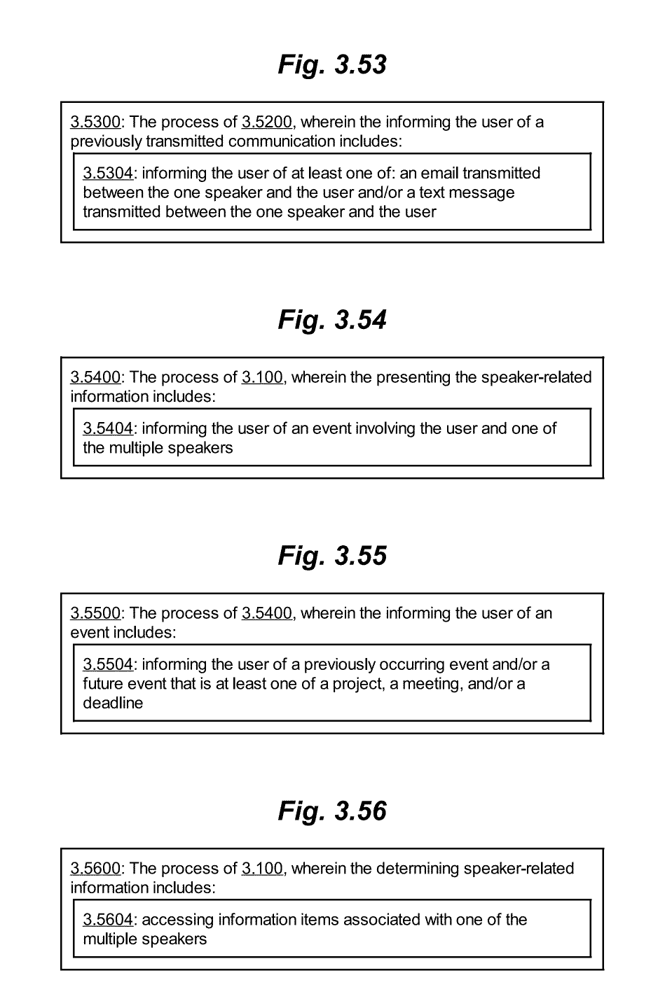

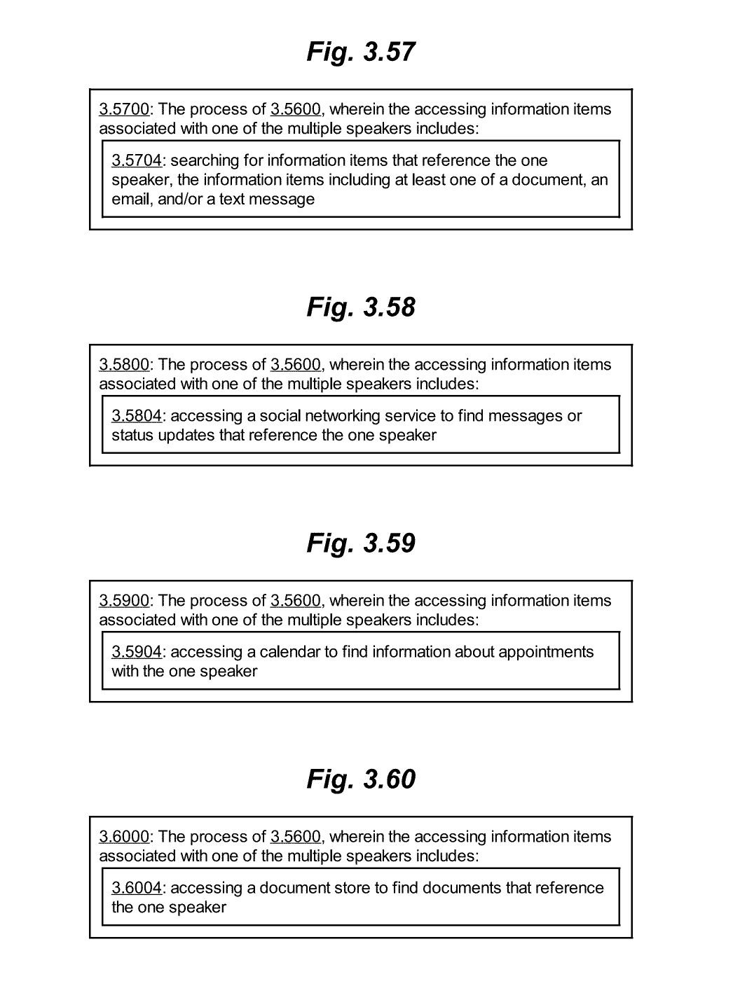

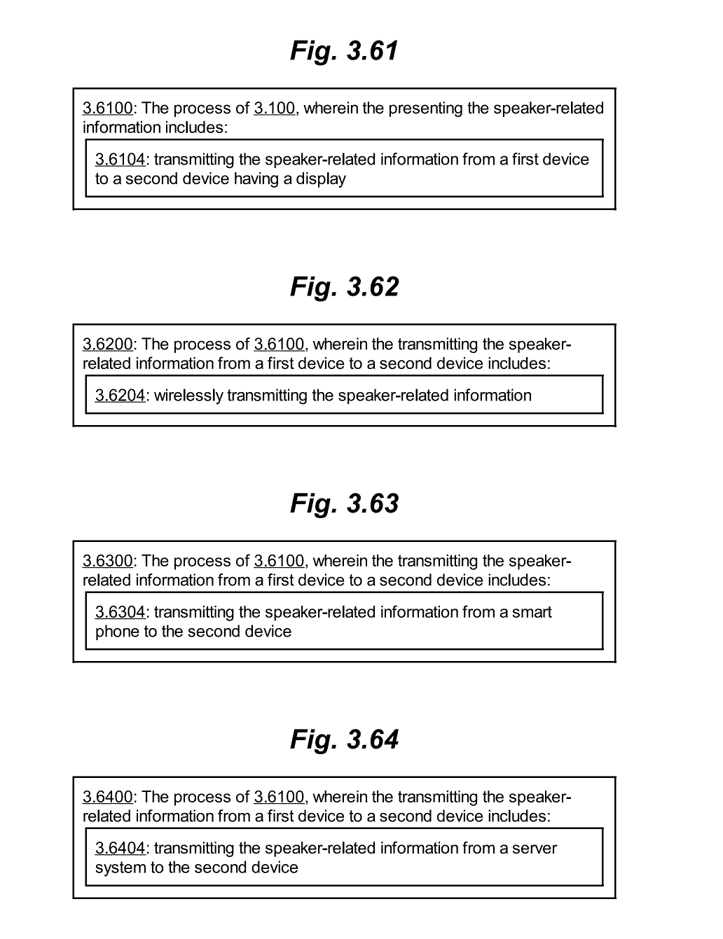

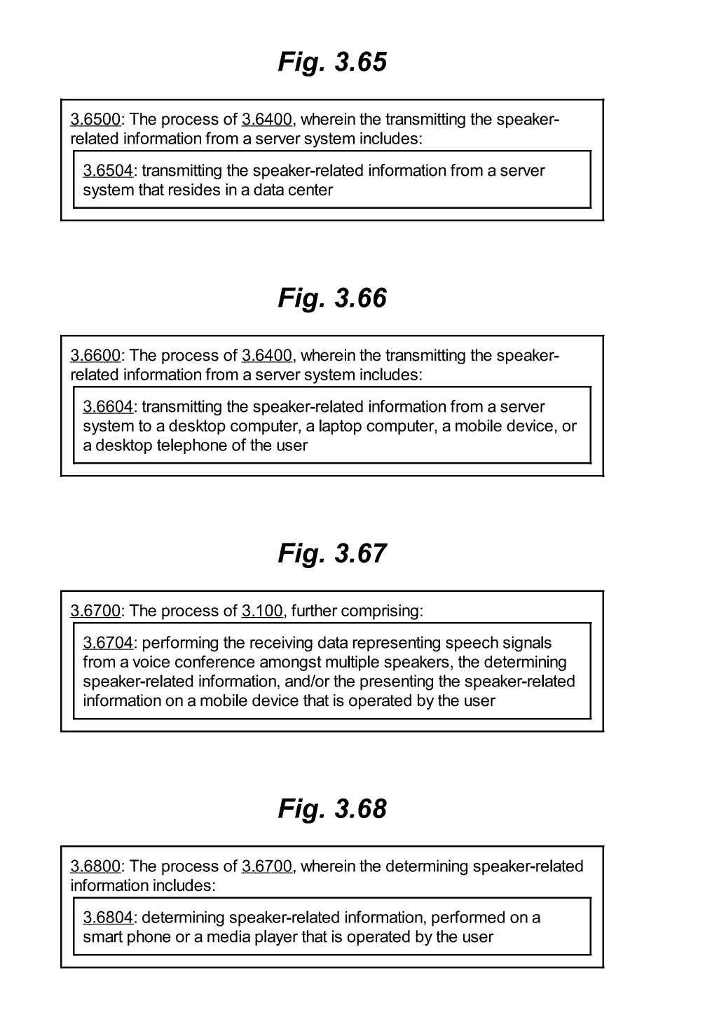

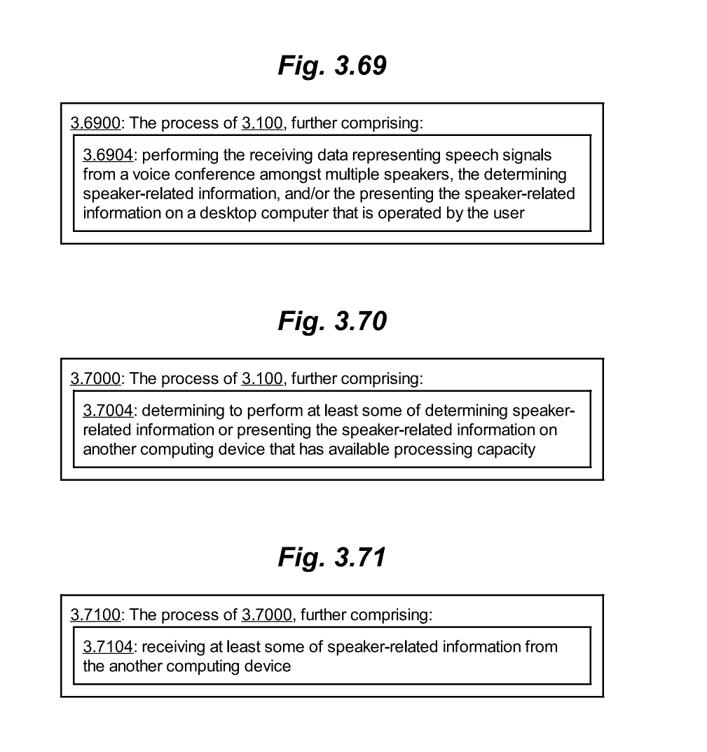

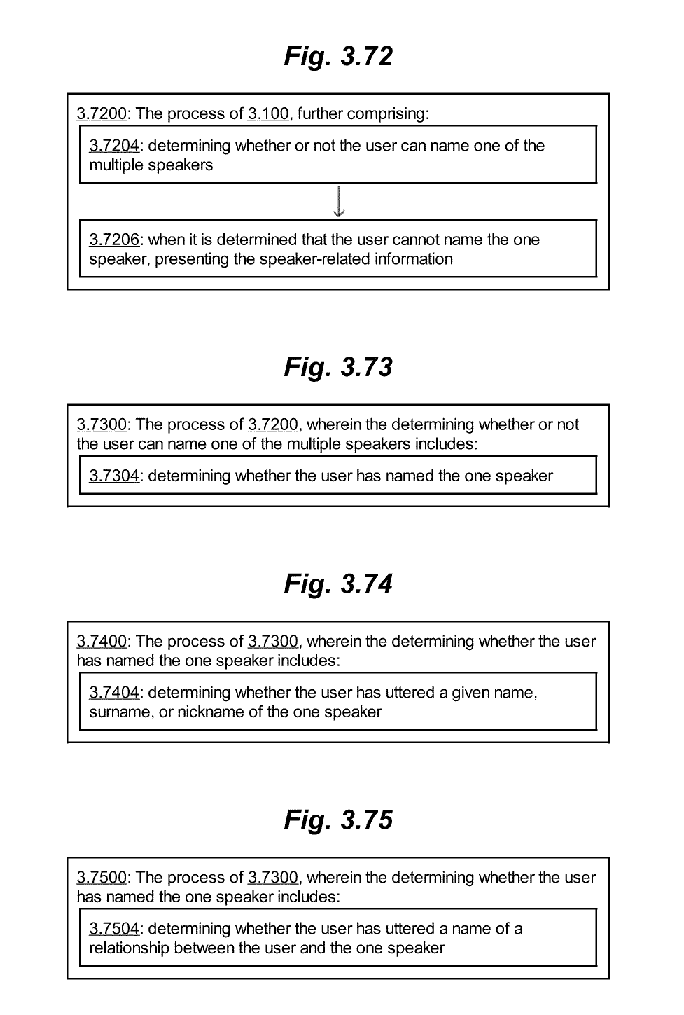

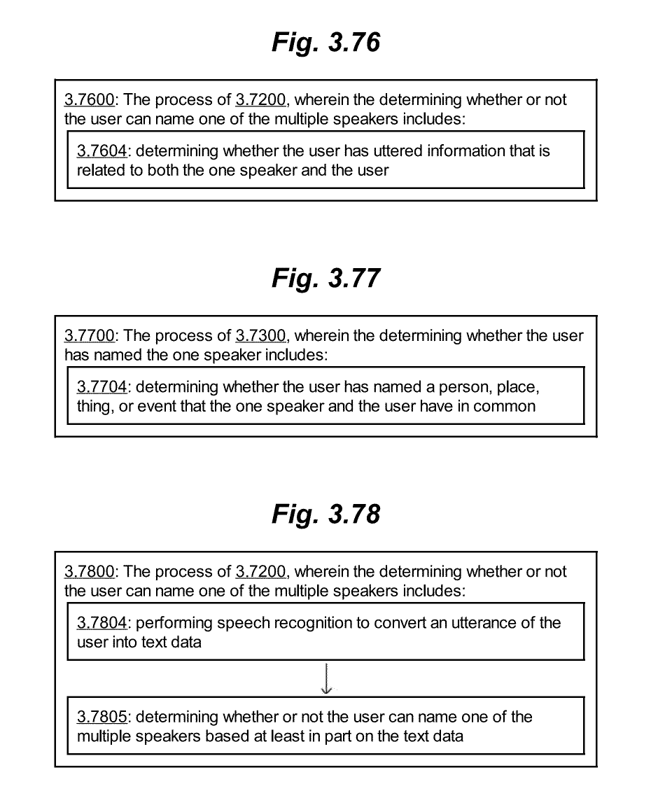

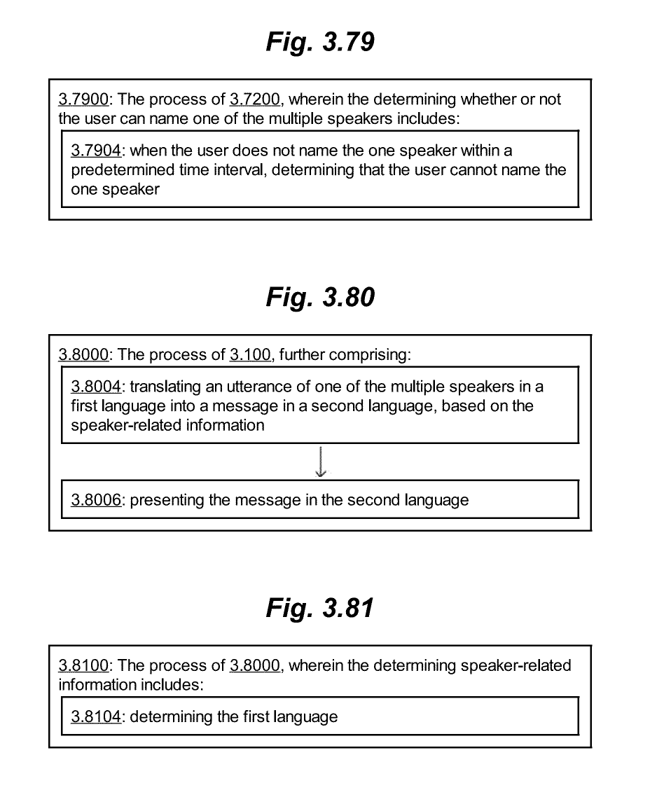

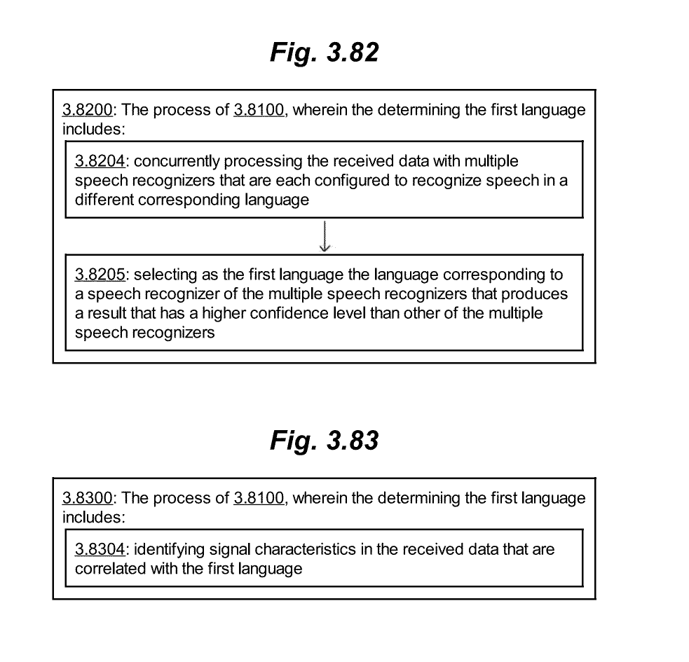

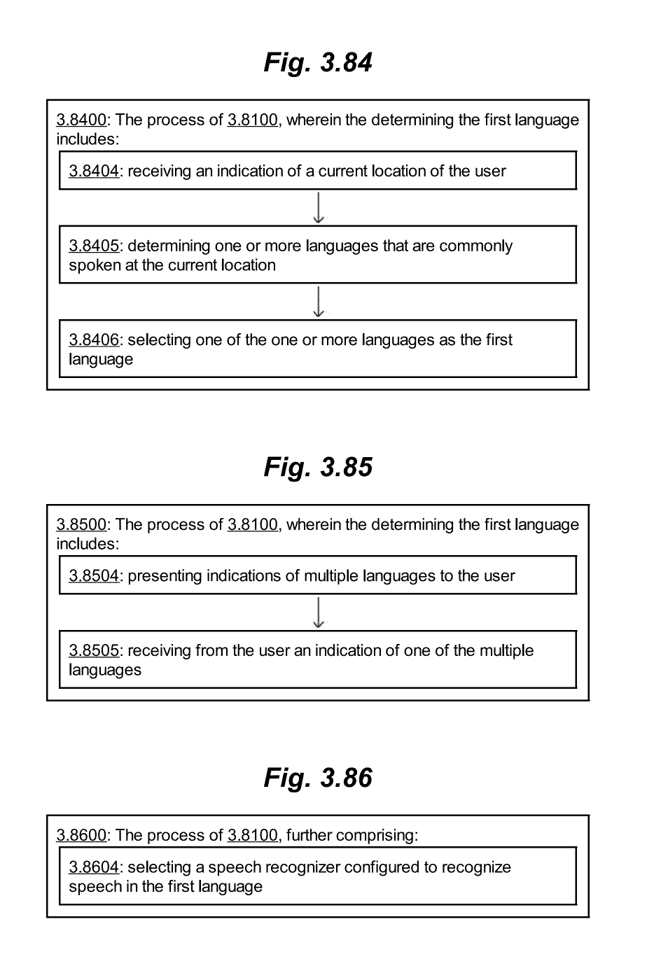

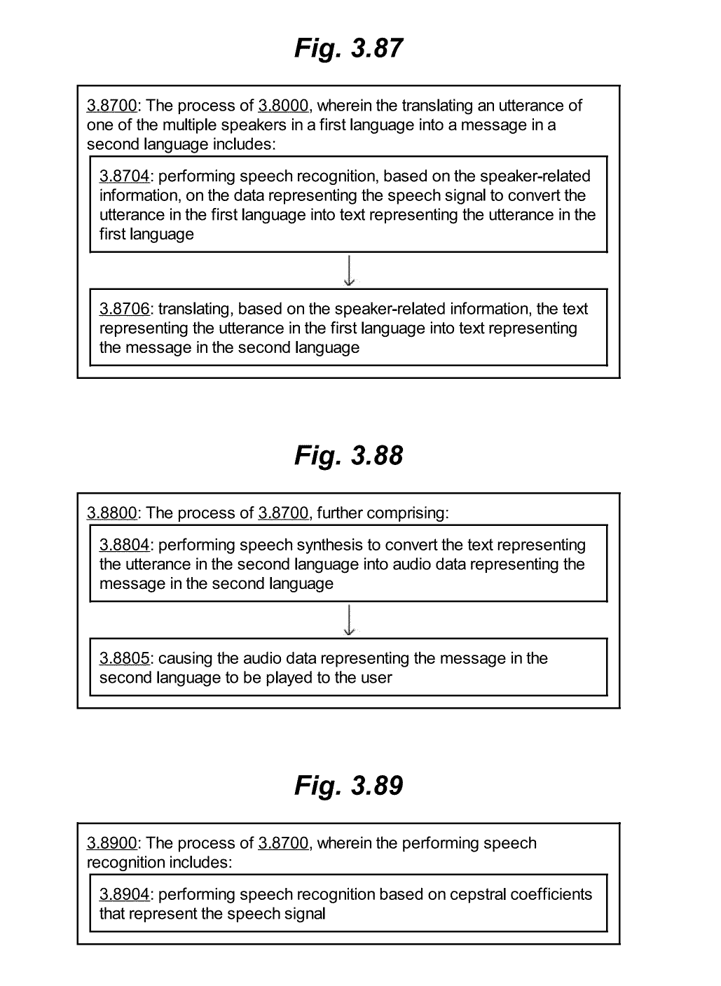

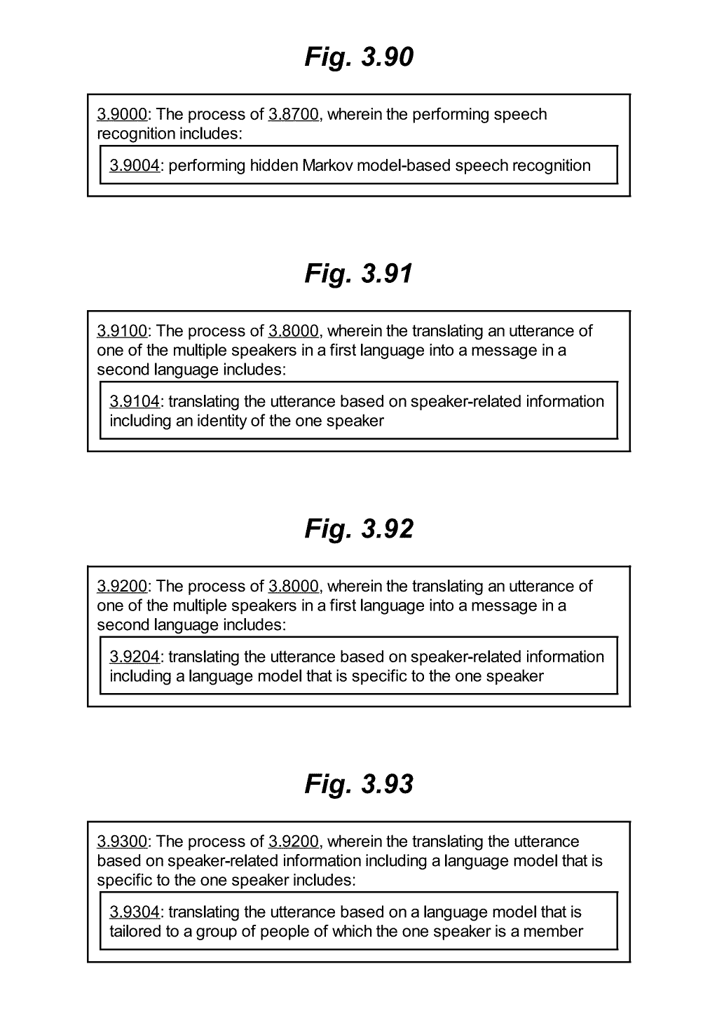

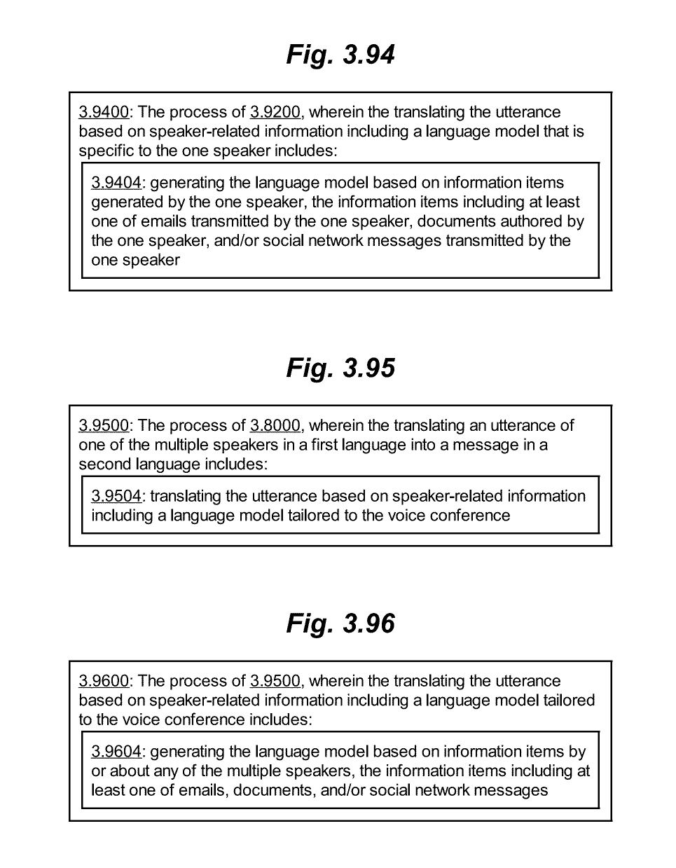

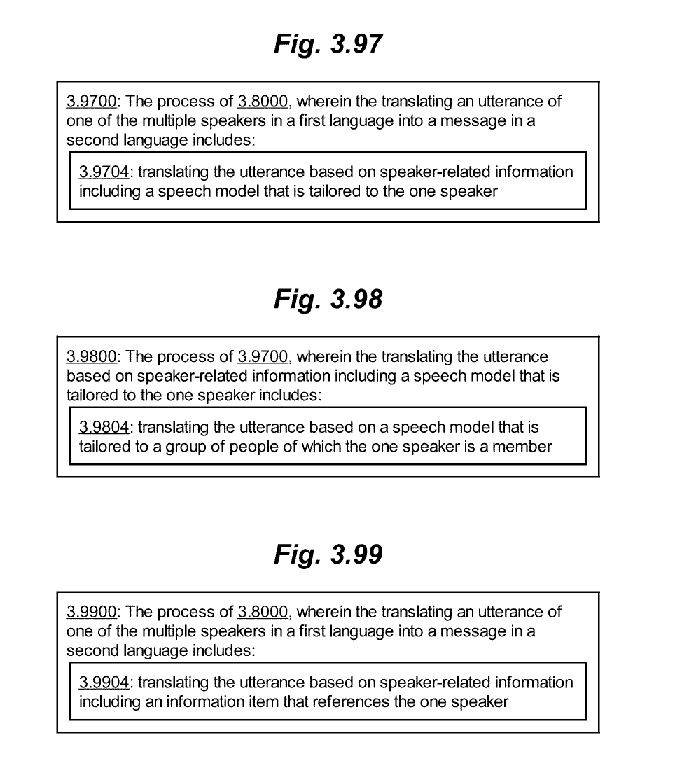

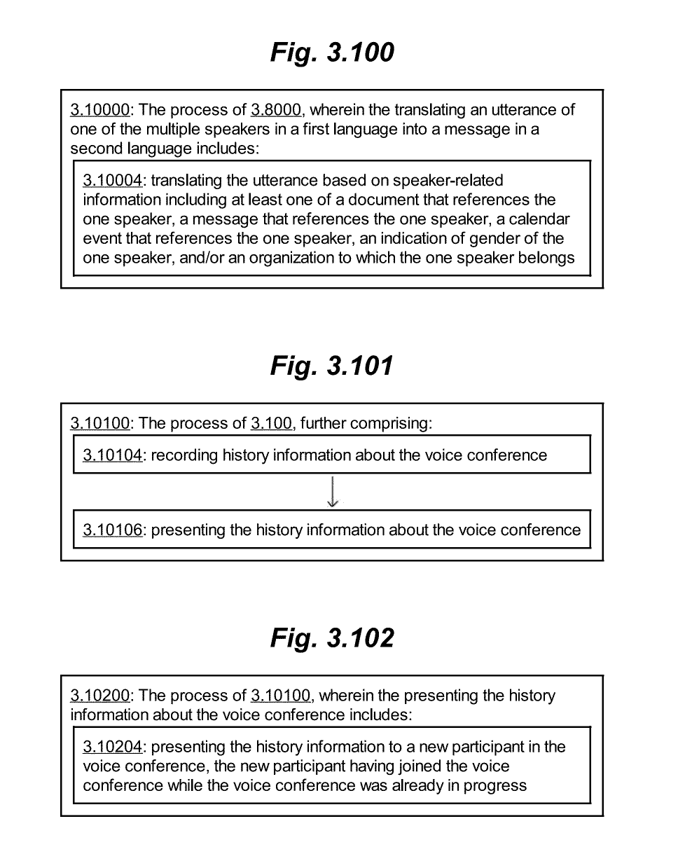

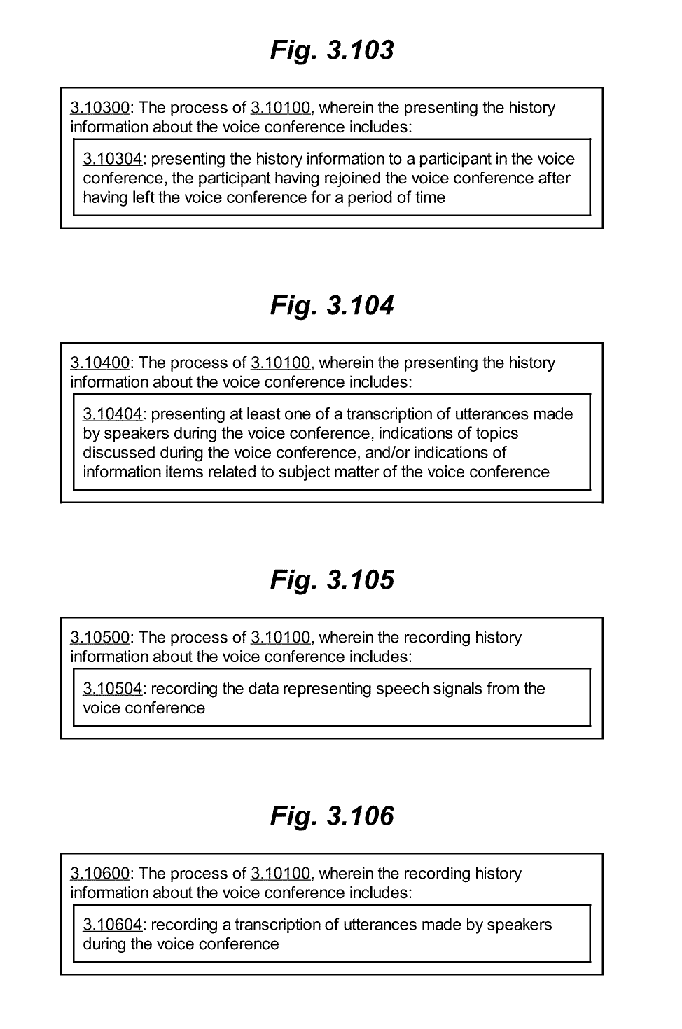

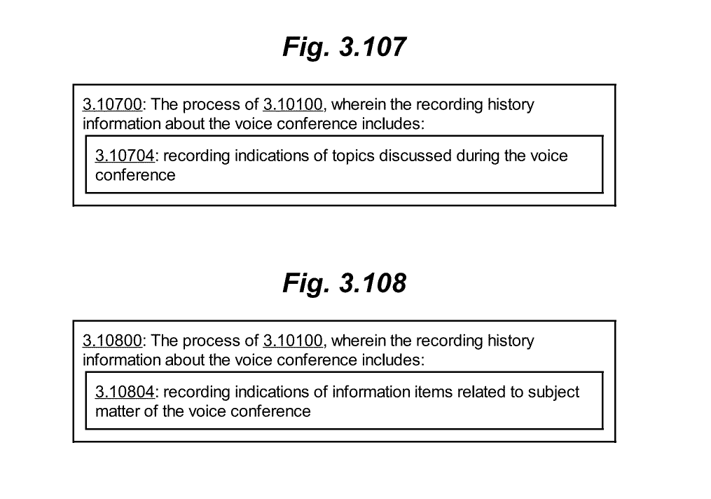

FIGS. 3.1-3.108 are example flow diagrams of ability enhancement processes performed by example embodiments.

FIG. 3.1 is an example flow diagram of example logic for ability enhancement. The illustrated logic in this and the following flow diagrams may be performed by, for example, a conferencing device 120 and/or one or more components of the AEFS 100 described with respect to FIG. 2, above. More particularly, FIG. 3.1 illustrates a process 3.100 that includes operations performed by or at the following block(s).

At block 3.103, the process performs receiving data representing speech signals from a voice conference amongst multiple speakers, wherein the multiple speakers include at least three speakers. The voice conference may be, for example, taking place between multiple speakers who are engaged in a conference call. The received data may be or represent one or more speech signals (e.g., audio samples) and/or higher-order information (e.g., frequency coefficients). The data may be received by or at the conferencing device 120 and/or the AEFS 100.

At block 3.105, the process performs determining speaker-related information associated with each of the multiple speakers, based on the data representing speech signals from the voice conference. The speaker-related information may include identifiers of a speaker (e.g., names, titles) and/or related information, such as documents, emails, calendar events, or the like. The speaker-related information may also or instead include demographic information about a speaker, including gender, language spoken, country of origin, region of origin, or the like. The speaker-related information may be determined based on signal properties of speech signals (e.g., a voice print) and/or on the semantic content of the speech signal, such as a name, event, entity, or information item that was mentioned by a speaker.

At block 3.107, the process performs presenting the speaker-related information via a conferencing device associated with a user. The speaker-related information may be presented on a display of the conferencing device (if it has one) or on some other display, such as a laptop or desktop display that is proximately located to the user. The speaker-related information may be presented in an audible and/or visible manner.

FIG. 3.2 is an example flow diagram of example logic illustrating an example embodiment of process 3.100 of FIG. 3.1. More particularly, FIG. 3.2 illustrates a process 3.200 that includes the process 3.100, wherein the receiving data representing speech signals from a voice conference amongst multiple speakers includes operations performed by or at the following block(s).

At block 3.204, the process performs receiving data representing speech signals from a voice conference amongst multiple speakers, wherein the multiple speakers are remotely located from one another. In some embodiments, the multiple speakers are remotely located from one another. Two speakers may be remotely located from one another even though they are in the same building or at the same site (e.g., campus, cluster of buildings), such as when the speakers are in different rooms, cubicles, or other locations within the site or building. In other cases, two speakers may be remotely located from one another by being in different cities, states, regions, or the like.

FIG. 3.3 is an example flow diagram of example logic illustrating an example embodiment of process 3.100 of FIG. 3.1. More particularly, FIG. 3.3 illustrates a process 3.300 that includes the process 3.100, wherein the presenting the speaker-related information includes operations performed by or at the following block(s).

At block 3.304, the process performs as each of the multiple speakers takes a turn speaking during the voice conference, presenting speaker-related information associated with the speaker. The process may, in substantially real time, provide the user speaker-related information associated a current speaker, such as a name of the speaker, a message sent by the speaker, or the like. The presented information may be updated throughout the voice conference based on the identity of the current speaker. For example, the process may present the three most recent emails sent by the current speaker.

FIG. 3.4 is an example flow diagram of example logic illustrating an example embodiment of process 3.300 of FIG. 3.3. More particularly, FIG. 3.4 illustrates a process 3.400 that includes the process 3.300, wherein the receiving data representing speech signals from a voice conference amongst multiple speakers includes operations performed by or at the following block(s).

At block 3.404, the process performs in response to one of the speakers beginning to speak during the voice conference, presenting the speaker-related information associated with the speaker. In some embodiments, the onset of speech may trigger the display or update of speaker-related information. The onset of speech may be detected in various ways, including via endpoint detection and/or frequency analysis.

FIG. 3.5 is an example flow diagram of example logic illustrating an example embodiment of process 3.100 of FIG. 3.1. More particularly, FIG. 3.5 illustrates a process 3.500 that includes the process 3.100, wherein the presenting the speaker-related information includes operations performed by or at the following block(s).

At block 3.504, the process performs presenting the speaker-related information during a telephone conference call amongst the multiple speakers. In some embodiments, the process operates to facilitate a telephone conference, even some or all of the speakers are using POTS (plain old telephone service) telephones.

FIG. 3.6 is an example flow diagram of example logic illustrating an example embodiment of process 3.100 of FIG. 3.1. More particularly, FIG. 3.6 illustrates a process 3.600 that includes the process 3.100 and which further includes operations performed by or at the following block(s).

At block 3.604, the process performs presenting, while a current speaker is speaking, speaker-related information on a display device of the user, the displayed speaker-related information identifying the current speaker. For example, as the user engages in a conference call from his office, the process may present the name or other information about the current speaker on a display of a desktop computer in the office of the user.

FIG. 3.7 is an example flow diagram of example logic illustrating an example embodiment of process 3.100 of FIG. 3.1. More particularly, FIG. 3.7 illustrates a process 3.700 that includes the process 3.100, wherein the receiving data representing speech signals from a voice conference amongst multiple speakers includes operations performed by or at the following block(s).

At block 3.704, the process performs receiving audio data from a telephone conference call that includes the multiple speakers, the received audio data representing utterances made by at least one of the multiple speakers. In some embodiments, the process may function in the context of a telephone conference, such as by receiving audio data from a system that facilitates the telephone conference, including a physical or virtual PBX (private branch exchange), a voice over IP conference system, or the like.

FIG. 3.8 is an example flow diagram of example logic illustrating an example embodiment of process 3.100 of FIG. 3.1. More particularly, FIG. 3.8 illustrates a process 3.800 that includes the process 3.100, wherein the receiving data representing speech signals from a voice conference amongst multiple speakers includes operations performed by or at the following block(s).

At block 3.804, the process performs receiving audio data from an online audio chat that includes the multiple speakers, the received audio data representing utterances made by at least one of the multiple speakers. In some embodiments, the process may function in the context of an online audio chat, such as may be supported by an online meeting system.

FIG. 3.9 is an example flow diagram of example logic illustrating an example embodiment of process 3.100 of FIG. 3.1. More particularly, FIG. 3.9 illustrates a process 3.900 that includes the process 3.100, wherein the receiving data representing speech signals from a voice conference amongst multiple speakers includes operations performed by or at the following block(s).

At block 3.904, the process performs receiving audio data from a video conference that includes the multiple speakers, the received audio data representing utterances made by at least one of the multiple speakers. In some embodiments, the process may function in the context of a video conference, such as may be facilitated by a dedicated system, a community of video enabled computing devices communicating via the Internet, or the like.

FIG. 3.10 is an example flow diagram of example logic illustrating an example embodiment of process 3.100 of FIG. 3.1. More particularly, FIG. 3.10 illustrates a process 3.1000 that includes the process 3.100, wherein the receiving data representing speech signals from a voice conference amongst multiple speakers includes operations performed by or at the following block(s).

At block 3.1004, the process performs receiving data representing speech signals from the at least three speakers, the data obtained at the conferencing device. In some embodiments, the process may obtain data from a conferencing device itself. In other cases, the process may obtain the data from an intermediary source or location.

FIG. 3.11 is an example flow diagram of example logic illustrating an example embodiment of process 3.100 of FIG. 3.1. More particularly, FIG. 3.11 illustrates a process 3.1100 that includes the process 3.100 and which further includes operations performed by or at the following block(s).

At block 3.1104, the process performs determining which one of the multiple speakers is speaking during a time interval. The process may determine which one of the speakers is currently speaking, even if the identity of the current speaker is not known. Various approaches may be employed, including detecting the source of a speech signal, performing voice identification, or the like.

FIG. 3.12 is an example flow diagram of example logic illustrating an example embodiment of process 3.1100 of FIG. 3.11. More particularly, FIG. 3.12 illustrates a process 3.1200 that includes the process 3.1100, wherein the determining which one of the multiple speakers is speaking during a time interval includes operations performed by or at the following block(s).

At block 3.1204, the process performs associating a first portion of the received data with a first one of the multiple speakers. The process may correspond, bind, link, or similarly associate a portion of the received data with a speaker. Such an association may then be used for further processing, such as voice identification, speech recognition, or the like.

FIG. 3.13 is an example flow diagram of example logic illustrating an example embodiment of process 3.1200 of FIG. 3.12. More particularly, FIG. 3.13 illustrates a process 3.1300 that includes the process 3.1200, wherein the associating a first portion of the received data with a first one of the multiple speakers includes operations performed by or at the following block(s).

At block 3.1304, the process performs receiving the first portion of the received data along with an identifier associated with the first speaker. In some embodiments, the process may receive data along with an identifier, such as an IP address (e.g., in a voice over IP conferencing system).

FIG. 3.14 is an example flow diagram of example logic illustrating an example embodiment of process 3.1300 of FIG. 3.13. More particularly, FIG. 3.14 illustrates a process 3.1400 that includes the process 3.1300, wherein the receiving the first portion of the received data along with an identifier associated with the first speaker includes operations performed by or at the following block(s).

At block 3.1404, the process performs receiving a network identifier associated with the first speaker.

FIG. 3.15 is an example flow diagram of example logic illustrating an example embodiment of process 3.1300 of FIG. 3.13. More particularly, FIG. 3.15 illustrates a process 3.1500 that includes the process 3.1300, wherein the receiving the first portion of the received data along with an identifier associated with the first speaker includes operations performed by or at the following block(s).

At block 3.1504, the process performs receiving from a conferencing system the identifier associated with the first speaker, the conferencing system configured to facilitate a conference call among the multiple speakers. Some conferencing systems may provide an identifier (e.g., telephone number) of a current speaker by detecting which telephone line or other circuit (virtual or physical) has an active signal.

FIG. 3.16 is an example flow diagram of example logic illustrating an example embodiment of process 3.1200 of FIG. 3.12. More particularly, FIG. 3.16 illustrates a process 3.1600 that includes the process 3.1200, wherein the associating a first portion of the received data with a first one of the multiple speakers includes operations performed by or at the following block(s).

At block 3.1604, the process performs selecting the first portion based on the first portion representing only speech from the one speaker and no other of the multiple speakers. The process may select a portion of the received data based on whether or not the received data includes speech from only one, or more than one speaker (e.g., when multiple speakers are talking over each other).

FIG. 3.17 is an example flow diagram of example logic illustrating an example embodiment of process 3.1100 of FIG. 3.11. More particularly, FIG. 3.17 illustrates a process 3.1700 that includes the process 3.1100 and which further includes operations performed by or at the following block(s).

At block 3.1704, the process performs determining that two or more of the multiple speakers are speaking concurrently. The process may determine the multiple speakers are talking at the same time, and take action accordingly. For example, the process may elect not to attempt to identify any speaker, or instead identify all of the speakers who are talking out of turn.

FIG. 3.18 is an example flow diagram of example logic illustrating an example embodiment of process 3.1100 of FIG. 3.11. More particularly, FIG. 3.18 illustrates a process 3.1800 that includes the process 3.1100, wherein the determining which one of the multiple speakers is speaking during a time interval includes operations performed by or at the following block(s).

At block 3.1804, the process performs performing voice identification to select which one of multiple previously analyzed voices is a best match for the one speaker who is speaking during the time interval. As noted, voice identification may be employed to determine the current speaker.

FIG. 3.19 is an example flow diagram of example logic illustrating an example embodiment of process 3.1100 of FIG. 3.11. More particularly, FIG. 3.19 illustrates a process 3.1900 that includes the process 3.1100, wherein the determining which one of the multiple speakers is speaking during a time interval includes operations performed by or at the following block(s).

At block 3.1904, the process performs performing voice identification based on the received data to identify one of the multiple speakers. In some embodiments, voice identification may include generating a voice print, voice model, or other biometric feature set that characterizes the voice of the speaker, and then comparing the generated voice print to previously generated voice prints.

FIG. 3.20 is an example flow diagram of example logic illustrating an example embodiment of process 3.1900 of FIG. 3.19. More particularly, FIG. 3.20 illustrates a process 3.2000 that includes the process 3.1900, wherein the performing voice identification includes operations performed by or at the following block(s).

At block 3.2004, the process performs comparing properties of the speech signal with properties of previously recorded speech signals from multiple persons. In some embodiments, the process accesses voice prints associated with multiple persons, and determines a best match against the speech signal.

FIG. 3.21 is an example flow diagram of example logic illustrating an example embodiment of process 3.2000 of FIG. 3.20. More particularly, FIG. 3.21 illustrates a process 3.2100 that includes the process 3.2000 and which further includes operations performed by or at the following block(s).

At block 3.2104, the process performs processing voice messages from the multiple persons to generate voice print data for each of the multiple persons. Given a telephone voice message, the process may associate generated voice print data for the voice message with one or more (direct or indirect) identifiers corresponding with the message. For example, the message may have a sender telephone number associated with it, and the process can use that sender telephone number to do a reverse directory lookup (e.g., in a public directory, in a personal contact list) to determine the name of the voice message speaker.

FIG. 3.22 is an example flow diagram of example logic illustrating an example embodiment of process 3.1900 of FIG. 3.19. More particularly, FIG. 3.22 illustrates a process 3.2200 that includes the process 3.1900, wherein the performing voice identification includes operations performed by or at the following block(s).

At block 3.2204, the process performs processing telephone voice messages stored by a voice mail service. In some embodiments, the process analyzes voice messages to generate voice prints/models for multiple persons.

FIG. 3.23 is an example flow diagram of example logic illustrating an example embodiment of process 3.1100 of FIG. 3.11. More particularly, FIG. 3.23 illustrates a process 3.2300 that includes the process 3.1100, wherein the determining which one of the multiple speakers is speaking during a time interval includes operations performed by or at the following block(s).

At block 3.2304, the process performs performing speech recognition to convert the received data into text data. For example, the process may convert the received data into a sequence of words that are (or are likely to be) the words uttered by a speaker.

At block 3.2306, the process performs identifying one of the multiple speakers based on the text data. Given text data (e.g., words spoken by a speaker), the process may search for information items that include the text data, and then identify the one speaker based on those information items, as discussed further below.

FIG. 3.24 is an example flow diagram of example logic illustrating an example embodiment of process 3.2300 of FIG. 3.23. More particularly, FIG. 3.24 illustrates a process 3.2400 that includes the process 3.2300, wherein the identifying one of the multiple speakers based on the text data includes operations performed by or at the following block(s).

At block 3.2404, the process performs finding an information item that references the one speaker and that includes one or more words in the text data. In some embodiments, the process may search for and find a document or other item (e.g., email, text message, status update) that includes words spoken by one speaker. Then, the process can infer that the one speaker is the author of the document, a recipient of the document, a person described in the document, or the like.

FIG. 3.25 is an example flow diagram of example logic illustrating an example embodiment of process 3.2300 of FIG. 3.23. More particularly, FIG. 3.25 illustrates a process 3.2500 that includes the process 3.2300, wherein the performing speech recognition includes operations performed by or at the following block(s).

At block 3.2504, the process performs performing speech recognition based on cepstral coefficients that represent the speech signal. In other embodiments, other types of features or information may be also or instead used to perform speech recognition, including language models, dialect models, or the like.

FIG. 3.26 is an example flow diagram of example logic illustrating an example embodiment of process 3.2300 of FIG. 3.23. More particularly, FIG. 3.26 illustrates a process 3.2600 that includes the process 3.2300, wherein the performing speech recognition includes operations performed by or at the following block(s).

At block 3.2604, the process performs performing hidden Markov model-based speech recognition. Other approaches or techniques for speech recognition may include neural networks, stochastic modeling, or the like.

FIG. 3.27 is an example flow diagram of example logic illustrating an example embodiment of process 3.2300 of FIG. 3.23. More particularly, FIG. 3.27 illustrates a process 3.2700 that includes the process 3.2300 and which further includes operations performed by or at the following block(s).

At block 3.2704, the process performs retrieving information items that reference the text data. The process may here retrieve or otherwise obtain documents, calendar events, messages, or the like, that include, contain, or otherwise reference some portion of the text data.

At block 3.2706, the process performs informing the user of the retrieved information items.

FIG. 3.28 is an example flow diagram of example logic illustrating an example embodiment of process 3.2300 of FIG. 3.23. More particularly, FIG. 3.28 illustrates a process 3.2800 that includes the process 3.2300, wherein the performing speech recognition includes operations performed by or at the following block(s).

At block 3.2804, the process performs performing speech recognition based at least in part on a language model associated with the one speaker. A language model may be used to improve or enhance speech recognition. For example, the language model may represent word transition likelihoods (e.g., by way of n-grams) that can be advantageously employed to enhance speech recognition. Furthermore, such a language model may be speaker specific, in that it may be based on communications or other information generated by the one speaker.

FIG. 3.29 is an example flow diagram of example logic illustrating an example embodiment of process 3.2800 of FIG. 3.28. More particularly, FIG. 3.29 illustrates a process 3.2900 that includes the process 3.2800, wherein the performing speech recognition based at least in part on a language model associated with the one speaker includes operations performed by or at the following block(s).

At block 3.2904, the process performs generating the language model based on information items generated by the one speaker, the information items including at least one of emails transmitted by the one speaker, documents authored by the one speaker, and/or social network messages transmitted by the one speaker. In some embodiments, the process mines or otherwise processes emails, text messages, voice messages, and the like to generate a language model that is specific or otherwise tailored to the one speaker.

FIG. 3.30 is an example flow diagram of example logic illustrating an example embodiment of process 3.2800 of FIG. 3.28. More particularly, FIG. 3.30 illustrates a process 3.3000 that includes the process 3.2800, wherein the performing speech recognition based at least in part on a language model associated with the one speaker includes operations performed by or at the following block(s).

At block 3.3004, the process performs generating the language model based on information items generated by or referencing any of the multiple speakers, the information items including emails, documents, and/or social network messages. In some embodiments, the process mines or otherwise processes emails, text messages, voice messages, and the like generated by or referencing any of the multiple speakers to generate a language model that is tailored to the current conversation.

FIG. 3.31 is an example flow diagram of example logic illustrating an example embodiment of process 3.1100 of FIG. 3.11. More particularly, FIG. 3.31 illustrates a process 3.3100 that includes the process 3.1100 and which further includes operations performed by or at the following block(s).

At block 3.3104, the process performs receiving data representing a speech signal that represents an utterance of the user. A microphone on or about the conferencing device may capture this data. The microphone may be the same or different from one used to capture speech data from the conversation.

At block 3.3106, the process performs identifying one of the multiple speakers based on the data representing a speech signal that represents an utterance of the user. Identifying the one speaker in this manner may include performing speech recognition on the user's utterance, and then processing the resulting text data to locate a name. This identification can then be utilized to retrieve information items or other speaker-related information that may be useful to present to the user.

FIG. 3.32 is an example flow diagram of example logic illustrating an example embodiment of process 3.3100 of FIG. 3.31. More particularly, FIG. 3.32 illustrates a process 3.3200 that includes the process 3.3100, wherein the identifying one of the multiple speakers based on the data representing a speech signal that represents an utterance of the user includes operations performed by or at the following block(s).

At block 3.3204, the process performs determining whether the utterance of the user includes a name of the one speaker.

FIG. 3.33 is an example flow diagram of example logic illustrating an example embodiment of process 3.100 of FIG. 3.1. More particularly, FIG. 3.33 illustrates a process 3.3300 that includes the process 3.100, wherein the determining speaker-related information includes operations performed by or at the following block(s).

At block 3.3304, the process performs receiving context information related to the user. Context information may generally include information about the setting, location, occupation, communication, workflow, or other event or factor that is present at, about, or with respect to the user.

At block 3.3306, the process performs determining speaker-related information, based on the context information. Context information may be used to determine speaker-related information, such as by determining or narrowing a set of potential speakers based on the current location of the user.

FIG. 3.34 is an example flow diagram of example logic illustrating an example embodiment of process 3.3300 of FIG. 3.33. More particularly, FIG. 3.34 illustrates a process 3.3400 that includes the process 3.3300, wherein the receiving context information related to the user includes operations performed by or at the following block(s).

At block 3.3404, the process performs receiving an indication of a location of the user.

At block 3.3406, the process performs determining a plurality of persons with whom the user commonly interacts at the location. For example, if the indicated location is a workplace, the process may generate a list of co-workers, thereby reducing or simplifying the problem of speaker identification.

FIG. 3.35 is an example flow diagram of example logic illustrating an example embodiment of process 3.3400 of FIG. 3.34. More particularly, FIG. 3.35 illustrates a process 3.3500 that includes the process 3.3400, wherein the receiving an indication of a location of the user includes operations performed by or at the following block(s).

At block 3.3504, the process performs receiving a GPS location from a mobile device of the user.

FIG. 3.36 is an example flow diagram of example logic illustrating an example embodiment of process 3.3400 of FIG. 3.34. More particularly, FIG. 3.36 illustrates a process 3.3600 that includes the process 3.3400, wherein the receiving an indication of a location of the user includes operations performed by or at the following block(s).

At block 3.3604, the process performs receiving a network identifier that is associated with the location. The network identifier may be, for example, a service set identifier (“SSID”) of a wireless network with which the user is currently associated.

FIG. 3.37 is an example flow diagram of example logic illustrating an example embodiment of process 3.3400 of FIG. 3.34. More particularly, FIG. 3.37 illustrates a process 3.3700 that includes the process 3.3400, wherein the receiving an indication of a location of the user includes operations performed by or at the following block(s).

At block 3.3704, the process performs receiving an indication that the user is at a workplace or a residence. For example, the process may translate a coordinate-based location (e.g., GPS coordinates) to a particular workplace by performing a map lookup or other mechanism.

FIG. 3.38 is an example flow diagram of example logic illustrating an example embodiment of process 3.3300 of FIG. 3.33. More particularly, FIG. 3.38 illustrates a process 3.3800 that includes the process 3.3300, wherein the receiving context information related to the user includes operations performed by or at the following block(s).

At block 3.3804, the process performs receiving information about an information item that references one of the multiple speakers. As noted, context information may include information items, such as documents, messages, calendar events, or the like. In this case, the process may exploit such information items to improve speaker identification or other operations.

FIG. 3.39 is an example flow diagram of example logic illustrating an example embodiment of process 3.1100 of FIG. 3.11. More particularly, FIG. 3.39 illustrates a process 3.3900 that includes the process 3.1100 and which further includes operations performed by or at the following block(s).

At block 3.3904, the process performs developing a corpus of speaker data by recording speech from multiple persons.

At block 3.3905, the process performs identifying one of the multiple speakers based at least in part on the corpus of speaker data. Over time, the process may gather and record speech obtained during its operation, and then use that speech as part of a corpus that is used during future operation. In this manner, the process may improve its performance by utilizing actual, environmental speech data, possibly along with feedback received from the user, as discussed below.

FIG. 3.40 is an example flow diagram of example logic illustrating an example embodiment of process 3.3900 of FIG. 3.39. More particularly, FIG. 3.40 illustrates a process 3.4000 that includes the process 3.3900 and which further includes operations performed by or at the following block(s).

At block 3.4004, the process performs generating a speech model associated with each of the multiple persons, based on the recorded speech. The generated speech model may include voice print data that can be used for speaker identification, a language model that may be used for speech recognition purposes, a noise model that may be used to improve operation in speaker-specific noisy environments.

FIG. 3.41 is an example flow diagram of example logic illustrating an example embodiment of process 3.3900 of FIG. 3.39. More particularly, FIG. 3.41 illustrates a process 3.4100 that includes the process 3.3900 and which further includes operations performed by or at the following block(s).

At block 3.4104, the process performs receiving feedback regarding accuracy of the speaker-related information. During or after providing speaker-related information to the user, the user may provide feedback regarding its accuracy. This feedback may then be used to train a speech processor (e.g., a speaker identification module, a speech recognition module). Feedback may be provided in various ways, such as by processing positive/negative utterances from a speaker (e.g., “That is not my name”), receiving a positive/negative utterance from the user (e.g., “I am sorry.”), receiving a keyboard/button event that indicates a correct or incorrect identification.

At block 3.4105, the process performs training a speech processor based at least in part on the received feedback.

FIG. 3.42 is an example flow diagram of example logic illustrating an example embodiment of process 3.100 of FIG. 3.1. More particularly, FIG. 3.42 illustrates a process 3.4200 that includes the process 3.100, wherein the presenting the speaker-related information includes operations performed by or at the following block(s).

At block 3.4204, the process performs presenting the speaker-related information on a display of the conferencing device. In some embodiments, the conferencing device may include a display. For example, where the conferencing device is a smart phone or laptop computer, the conferencing device may include a display that provides a suitable medium for presenting the name or other identifier of the speaker.

FIG. 3.43 is an example flow diagram of example logic illustrating an example embodiment of process 3.100 of FIG. 3.1. More particularly, FIG. 3.43 illustrates a process 3.4300 that includes the process 3.100, wherein the presenting the speaker-related information includes operations performed by or at the following block(s).

At block 3.4304, the process performs presenting the speaker-related information on a display of a computing device that is distinct from the conferencing device. In some embodiments, the conferencing device may not itself include a display. For example, where the conferencing device is an office phone, the process may elect to present the speaker-related information on a display of a nearby computing device, such as a desktop or laptop computer in the vicinity of the phone.

FIG. 3.44 is an example flow diagram of example logic illustrating an example embodiment of process 3.100 of FIG. 3.1. More particularly, FIG. 3.44 illustrates a process 3.4400 that includes the process 3.100, wherein the presenting the speaker-related information includes operations performed by or at the following block(s).

At block 3.4404, the process performs determining a display to serve as a presentation device for the speaker-related information. In some embodiments, there may be multiple displays available as possible destinations for the speaker-related information. For example, in an office setting, where the conferencing device is an office phone, the office phone may include a small LCD display suitable for displaying a few characters or at most a few lines of text. However, there will typically be additional devices in the vicinity of the conferencing device, such as a desktop/laptop computer, a smart phone, a PDA, or the like. The process may determine to use one or more of these other display devices, possibly based on the type of the speaker-related information being displayed.

FIG. 3.45 is an example flow diagram of example logic illustrating an example embodiment of process 3.4400 of FIG. 3.44. More particularly, FIG. 3.45 illustrates a process 3.4500 that includes the process 3.4400, wherein the determining a display includes operations performed by or at the following block(s).

At block 3.4504, the process performs selecting one display from multiple displays, based at least in part on whether each of the multiple displays is capable of displaying all of the speaker-related information. In some embodiments, the process determines whether all of the speaker-related information can be displayed on a given display. For example, where the display is a small alphanumeric display on an office phone, the process may determine that the display is not capable of displaying a large amount of speaker-related information.

FIG. 3.46 is an example flow diagram of example logic illustrating an example embodiment of process 3.4400 of FIG. 3.44. More particularly, FIG. 3.46 illustrates a process 3.4600 that includes the process 3.4400, wherein the determining a display includes operations performed by or at the following block(s).

At block 3.4604, the process performs selecting one display from multiple displays, based at least in part on a size of each of the multiple displays. In some embodiments, the process considers the size (e.g., the number of characters or pixels that can be displayed) of each display.

FIG. 3.47 is an example flow diagram of example logic illustrating an example embodiment of process 3.4400 of FIG. 3.44. More particularly, FIG. 3.47 illustrates a process 3.4700 that includes the process 3.4400, wherein the determining a display includes operations performed by or at the following block(s).

At block 3.4704, the process performs selecting one display from multiple displays, based at least in part on whether each of the multiple displays is suitable for displaying the speaker-related information, the speaker-related information being at least one of text information, a communication, a document, an image, and/or a calendar event. In some embodiments, the process considers the type of the speaker-related information. For example, whereas a small alphanumeric display on an office phone may be suitable for displaying the name of the speaker, it would not be suitable for displaying an email message sent by the speaker.

FIG. 3.48 is an example flow diagram of example logic illustrating an example embodiment of process 3.100 of FIG. 3.1. More particularly, FIG. 3.48 illustrates a process 3.4800 that includes the process 3.100 and which further includes operations performed by or at the following block(s).

At block 3.4804, the process performs audibly notifying the user to view the speaker-related information on a display device. In some embodiments, notifying the user may include playing a tone, such as a beep, chime, or other type of notification. In some embodiments, notifying the user may include playing synthesized speech telling the user to view the display device. For example, the process may perform text-to-speech processing to generate audio of a textual message or notification, and this audio may then be played or otherwise output to the user via the conferencing device. In some embodiments, notifying the user may telling the user that a document, calendar event, communication, or the like is available for viewing on the display device. Telling the user about a document or other speaker-related information may include playing synthesized speech that includes an utterance to that effect. In some embodiments, the process may notify the user in a manner that is not audible to at least some of the multiple speakers. For example, a tone or verbal message may be output via an earpiece speaker, such that other parties to the conversation do not hear the notification. As another example, a tone or other notification may be into the earpiece of a telephone, such as when the process is performing its functions within the context of a telephonic conference call.

FIG. 3.49 is an example flow diagram of example logic illustrating an example embodiment of process 3.100 of FIG. 3.1. More particularly, FIG. 3.49 illustrates a process 3.4900 that includes the process 3.100, wherein the presenting the speaker-related information includes operations performed by or at the following block(s).

At block 3.4904, the process performs informing the user of an identifier of each of the multiple speakers. In some embodiments, the identifier of each of the speakers may be or include a given name, surname (e.g., last name, family name), nickname, title, job description, or other type of identifier of or associated with the speaker.

FIG. 3.50 is an example flow diagram of example logic illustrating an example embodiment of process 3.100 of FIG. 3.1. More particularly, FIG. 3.50 illustrates a process 3.5000 that includes the process 3.100, wherein the presenting the speaker-related information includes operations performed by or at the following block(s).

At block 3.5004, the process performs informing the user of information aside from identifying information related to the multiple speakers. In some embodiments, information aside from identifying information may include information that is not a name or other identifier (e.g., job title) associated with the speaker. For example, the process may tell the user about an event or communication associated with or related to the speaker.

FIG. 3.51 is an example flow diagram of example logic illustrating an example embodiment of process 3.100 of FIG. 3.1. More particularly, FIG. 3.51 illustrates a process 3.5100 that includes the process 3.100, wherein the presenting the speaker-related information includes operations performed by or at the following block(s).

At block 3.5104, the process performs informing the user of an organization to which each of the multiple speakers belongs. In some embodiments, informing the user of an organization may include notifying the user of a business, group, school, club, team, company, or other formal or informal organization with which a speaker is affiliated. Companies may include profit or non-profit entities, regardless of organizational structure (e.g., corporation, partnerships, sole proprietorship).

FIG. 3.52 is an example flow diagram of example logic illustrating an example embodiment of process 3.100 of FIG. 3.1. More particularly, FIG. 3.52 illustrates a process 3.5200 that includes the process 3.100, wherein the presenting the speaker-related information includes operations performed by or at the following block(s).

At block 3.5204, the process performs informing the user of a previously transmitted communication referencing one of the multiple speakers. Various forms of communication are contemplated, including textual (e.g., emails, text messages, chats), audio (e.g., voice messages), video, or the like. In some embodiments, a communication can include content in multiple forms, such as text and audio, such as when an email includes a voice attachment.

FIG. 3.53 is an example flow diagram of example logic illustrating an example embodiment of process 3.5200 of FIG. 3.52. More particularly, FIG. 3.53 illustrates a process 3.5300 that includes the process 3.5200, wherein the informing the user of a previously transmitted communication includes operations performed by or at the following block(s).

At block 3.5304, the process performs informing the user of at least one of: an email transmitted between the one speaker and the user and/or a text message transmitted between the one speaker and the user. An email transmitted between the one speaker and the user may include an email sent from the one speaker to the user, or vice versa. Text messages may include short messages according to various protocols, including SMS, MMS, and the like.

FIG. 3.54 is an example flow diagram of example logic illustrating an example embodiment of process 3.100 of FIG. 3.1. More particularly, FIG. 3.54 illustrates a process 3.5400 that includes the process 3.100, wherein the presenting the speaker-related information includes operations performed by or at the following block(s).

At block 3.5404, the process performs informing the user of an event involving the user and one of the multiple speakers. An event may be any occurrence that involves or involved the user and a speaker, such as a meeting (e.g., social or professional meeting or gathering) attended by the user and the speaker, an upcoming deadline (e.g., for a project), or the like.

FIG. 3.55 is an example flow diagram of example logic illustrating an example embodiment of process 3.5400 of FIG. 3.54. More particularly, FIG. 3.55 illustrates a process 3.5500 that includes the process 3.5400, wherein the informing the user of an event includes operations performed by or at the following block(s).

At block 3.5504, the process performs informing the user of a previously occurring event and/or a future event that is at least one of a project, a meeting, and/or a deadline.

FIG. 3.56 is an example flow diagram of example logic illustrating an example embodiment of process 3.100 of FIG. 3.1. More particularly, FIG. 3.56 illustrates a process 3.5600 that includes the process 3.100, wherein the determining speaker-related information includes operations performed by or at the following block(s).

At block 3.5604, the process performs accessing information items associated with one of the multiple speakers. In some embodiments, accessing information items associated with one of the multiple speakers may include retrieving files, documents, data records, or the like from various sources, such as local or remote storage devices, cloud-based servers, and the like. In some embodiments, accessing information items may also or instead include scanning, searching, indexing, or otherwise processing information items to find ones that include, name, mention, or otherwise reference a speaker.

FIG. 3.57 is an example flow diagram of example logic illustrating an example embodiment of process 3.5600 of FIG. 3.56. More particularly, FIG. 3.57 illustrates a process 3.5700 that includes the process 3.5600, wherein the accessing information items associated with one of the multiple speakers includes operations performed by or at the following block(s).

At block 3.5704, the process performs searching for information items that reference the one speaker, the information items including at least one of a document, an email, and/or a text message. In some embodiments, searching may include formulating a search query to provide to a document management system or any other data/document store that provides a search interface. In some embodiments, emails or text messages that reference the one speaker may include messages sent from the one speaker, messages sent to the one speaker, messages that name or otherwise identify the one speaker in the body of the message, or the like.

FIG. 3.58 is an example flow diagram of example logic illustrating an example embodiment of process 3.5600 of FIG. 3.56. More particularly, FIG. 3.58 illustrates a process 3.5800 that includes the process 3.5600, wherein the accessing information items associated with one of the multiple speakers includes operations performed by or at the following block(s).

At block 3.5804, the process performs accessing a social networking service to find messages or status updates that reference the one speaker. In some embodiments, accessing a social networking service may include searching for postings, status updates, personal messages, or the like that have been posted by, posted to, or otherwise reference the one speaker. Example social networking services include Facebook, Twitter, Google Plus, and the like. Access to a social networking service may be obtained via an API or similar interface that provides access to social networking data related to the user and/or the one speaker.

FIG. 3.59 is an example flow diagram of example logic illustrating an example embodiment of process 3.5600 of FIG. 3.56. More particularly, FIG. 3.59 illustrates a process 3.5900 that includes the process 3.5600, wherein the accessing information items associated with one of the multiple speakers includes operations performed by or at the following block(s).

At block 3.5904, the process performs accessing a calendar to find information about appointments with the one speaker. In some embodiments, accessing a calendar may include searching a private or shared calendar to locate a meeting or other appointment with the one speaker, and providing such information to the user via the conferencing device.

FIG. 3.60 is an example flow diagram of example logic illustrating an example embodiment of process 3.5600 of FIG. 3.56. More particularly, FIG. 3.60 illustrates a process 3.6000 that includes the process 3.5600, wherein the accessing information items associated with one of the multiple speakers includes operations performed by or at the following block(s).

At block 3.6004, the process performs accessing a document store to find documents that reference the one speaker. In some embodiments, documents that reference the one speaker include those that are authored at least in part by the one speaker, those that name or otherwise identify the speaker in a document body, or the like. Accessing the document store may include accessing a local or remote storage device/system, accessing a document management system, accessing a source control system, or the like.

FIG. 3.61 is an example flow diagram of example logic illustrating an example embodiment of process 3.100 of FIG. 3.1. More particularly, FIG. 3.61 illustrates a process 3.6100 that includes the process 3.100, wherein the presenting the speaker-related information includes operations performed by or at the following block(s).

At block 3.6104, the process performs transmitting the speaker-related information from a first device to a second device having a display. In some embodiments, at least some of the processing may be performed on distinct devices, resulting in a transmission of speaker-related information from one device to another device, for example from a desktop computer to the conferencing device.

FIG. 3.62 is an example flow diagram of example logic illustrating an example embodiment of process 3.6100 of FIG. 3.61. More particularly, FIG. 3.62 illustrates a process 3.6200 that includes the process 3.6100, wherein the transmitting the speaker-related information from a first device to a second device includes operations performed by or at the following block(s).

At block 3.6204, the process performs wirelessly transmitting the speaker-related information. Various protocols may be used, including Bluetooth, infrared, WiFi, or the like.

FIG. 3.63 is an example flow diagram of example logic illustrating an example embodiment of process 3.6100 of FIG. 3.61. More particularly, FIG. 3.63 illustrates a process 3.6300 that includes the process 3.6100, wherein the transmitting the speaker-related information from a first device to a second device includes operations performed by or at the following block(s).

At block 3.6304, the process performs transmitting the speaker-related information from a smart phone to the second device. For example a smart phone may forward the speaker-related information to a desktop computing system for display on an associated monitor.

FIG. 3.64 is an example flow diagram of example logic illustrating an example embodiment of process 3.6100 of FIG. 3.61. More particularly, FIG. 3.64 illustrates a process 3.6400 that includes the process 3.6100, wherein the transmitting the speaker-related information from a first device to a second device includes operations performed by or at the following block(s).

At block 3.6404, the process performs transmitting the speaker-related information from a server system to the second device. In some embodiments, some portion of the processing is performed on a server system that may be remote from the conferencing device.

FIG. 3.65 is an example flow diagram of example logic illustrating an example embodiment of process 3.6400 of FIG. 3.64. More particularly, FIG. 3.65 illustrates a process 3.6500 that includes the process 3.6400, wherein the transmitting the speaker-related information from a server system includes operations performed by or at the following block(s).

At block 3.6504, the process performs transmitting the speaker-related information from a server system that resides in a data center.

FIG. 3.66 is an example flow diagram of example logic illustrating an example embodiment of process 3.6400 of FIG. 3.64. More particularly, FIG. 3.66 illustrates a process 3.6600 that includes the process 3.6400, wherein the transmitting the speaker-related information from a server system includes operations performed by or at the following block(s).

At block 3.6604, the process performs transmitting the speaker-related information from a server system to a desktop computer, a laptop computer, a mobile device, or a desktop telephone of the user.

FIG. 3.67 is an example flow diagram of example logic illustrating an example embodiment of process 3.100 of FIG. 3.1. More particularly, FIG. 3.67 illustrates a process 3.6700 that includes the process 3.100 and which further includes operations performed by or at the following block(s).

At block 3.6704, the process performs performing the receiving data representing speech signals from a voice conference amongst multiple speakers, the determining speaker-related information, and/or the presenting the speaker-related information on a mobile device that is operated by the user. As noted, in some embodiments a computer or mobile device such as a smart phone may have sufficient processing power to perform a portion of the process, such as identifying a speaker, determining the speaker-related information, or the like.

FIG. 3.68 is an example flow diagram of example logic illustrating an example embodiment of process 3.6700 of FIG. 3.67. More particularly, FIG. 3.68 illustrates a process 3.6800 that includes the process 3.6700, wherein the determining speaker-related information includes operations performed by or at the following block(s).

At block 3.6804, the process performs determining speaker-related information, performed on a smart phone or a media player that is operated by the user.

FIG. 3.69 is an example flow diagram of example logic illustrating an example embodiment of process 3.100 of FIG. 3.1. More particularly, FIG. 3.69 illustrates a process 3.6900 that includes the process 3.100 and which further includes operations performed by or at the following block(s).

At block 3.6904, the process performs performing the receiving data representing speech signals from a voice conference amongst multiple speakers, the determining speaker-related information, and/or the presenting the speaker-related information on a desktop computer that is operated by the user. For example, in an office setting, the user's desktop computer may be configured to perform some or all of the process.

FIG. 3.70 is an example flow diagram of example logic illustrating an example embodiment of process 3.100 of FIG. 3.1. More particularly, FIG. 3.70 illustrates a process 3.7000 that includes the process 3.100 and which further includes operations performed by or at the following block(s).

At block 3.7004, the process performs determining to perform at least some of determining speaker-related information or presenting the speaker-related information on another computing device that has available processing capacity. In some embodiments, the process may determine to offload some of its processing to another computing device or system.

FIG. 3.71 is an example flow diagram of example logic illustrating an example embodiment of process 3.7000 of FIG. 3.70. More particularly, FIG. 3.71 illustrates a process 3.7100 that includes the process 3.7000 and which further includes operations performed by or at the following block(s).

At block 3.7104, the process performs receiving at least some of speaker-related information from the another computing device. The process may receive the speaker-related information or a portion thereof from the other computing device.

FIG. 3.72 is an example flow diagram of example logic illustrating an example embodiment of process 3.100 of FIG. 3.1. More particularly, FIG. 3.72 illustrates a process 3.7200 that includes the process 3.100 and which further includes operations performed by or at the following block(s).

At block 3.7204, the process performs determining whether or not the user can name one of the multiple speakers.

At block 3.7206, the process performs when it is determined that the user cannot name the one speaker, presenting the speaker-related information. In some embodiments, the process only informs the user of the speaker-related information upon determining that the user does not appear to be able to name a particular speaker.

FIG. 3.73 is an example flow diagram of example logic illustrating an example embodiment of process 3.7200 of FIG. 3.72. More particularly, FIG. 3.73 illustrates a process 3.7300 that includes the process 3.7200, wherein the determining whether or not the user can name one of the multiple speakers includes operations performed by or at the following block(s).

At block 3.7304, the process performs determining whether the user has named the one speaker. In some embodiments, the process listens to the user to determine whether the user has named the speaker.

FIG. 3.74 is an example flow diagram of example logic illustrating an example embodiment of process 3.7300 of FIG. 3.73. More particularly, FIG. 3.74 illustrates a process 3.7400 that includes the process 3.7300, wherein the determining whether the user has named the one speaker includes operations performed by or at the following block(s).

At block 3.7404, the process performs determining whether the user has uttered a given name, surname, or nickname of the one speaker.

FIG. 3.75 is an example flow diagram of example logic illustrating an example embodiment of process 3.7300 of FIG. 3.73. More particularly, FIG. 3.75 illustrates a process 3.7500 that includes the process 3.7300, wherein the determining whether the user has named the one speaker includes operations performed by or at the following block(s).

At block 3.7504, the process performs determining whether the user has uttered a name of a relationship between the user and the one speaker. In some embodiments, the user need not utter the name of the speaker, but instead may utter other information (e.g., a relationship) that may be used by the process to determine that user knows or can name the speaker.

FIG. 3.76 is an example flow diagram of example logic illustrating an example embodiment of process 3.7200 of FIG. 3.72. More particularly, FIG. 3.76 illustrates a process 3.7600 that includes the process 3.7200, wherein the determining whether or not the user can name one of the multiple speakers includes operations performed by or at the following block(s).

At block 3.7604, the process performs determining whether the user has uttered information that is related to both the one speaker and the user.

FIG. 3.77 is an example flow diagram of example logic illustrating an example embodiment of process 3.7300 of FIG. 3.73. More particularly, FIG. 3.77 illustrates a process 3.7700 that includes the process 3.7300, wherein the determining whether the user has named the one speaker includes operations performed by or at the following block(s).

At block 3.7704, the process performs determining whether the user has named a person, place, thing, or event that the one speaker and the user have in common. For example, the user may mention a visit to the home town of the speaker, a vacation to a place familiar to the speaker, or the like.

FIG. 3.78 is an example flow diagram of example logic illustrating an example embodiment of process 3.7200 of FIG. 3.72. More particularly, FIG. 3.78 illustrates a process 3.7800 that includes the process 3.7200, wherein the determining whether or not the user can name one of the multiple speakers includes operations performed by or at the following block(s).

At block 3.7804, the process performs performing speech recognition to convert an utterance of the user into text data. The process may perform speech recognition on utterances of the user, and then examine the resulting text to determine whether the user has uttered a name or other information about the speaker.

At block 3.7805, the process performs determining whether or not the user can name one of the multiple speakers based at least in part on the text data.

FIG. 3.79 is an example flow diagram of example logic illustrating an example embodiment of process 3.7200 of FIG. 3.72. More particularly, FIG. 3.79 illustrates a process 3.7900 that includes the process 3.7200, wherein the determining whether or not the user can name one of the multiple speakers includes operations performed by or at the following block(s).

At block 3.7904, the process performs when the user does not name the one speaker within a predetermined time interval, determining that the user cannot name the one speaker. In some embodiments, the process waits for a time period before jumping in to provide the speaker-related information.

FIG. 3.80 is an example flow diagram of example logic illustrating an example embodiment of process 3.100 of FIG. 3.1. More particularly, FIG. 3.80 illustrates a process 3.8000 that includes the process 3.100 and which further includes operations performed by or at the following block(s).

At block 3.8004, the process performs translating an utterance of one of the multiple speakers in a first language into a message in a second language, based on the speaker-related information. In some embodiments, the process may also perform language translation, such that a voice conference may be held between speakers of different languages. In some embodiments, the utterance may be translated by first performing speech recognition on the data representing the speech signal to convert the utterance into textual form. Then, the text of the utterance may be translated into the second language using a natural language processing and/or machine translation techniques. The speaker-related information may be used to improve, enhance, or otherwise modify the process of machine translation. For example, based on the identity of the one speaker, the process may use a language or speech model that is tailored to the one speaker in order to improve a machine translation process. As another example, the process may use one or more information items that reference the one speaker to improve machine translation, such as by disambiguating references in the utterance of the one speaker.

At block 3.8006, the process performs presenting the message in the second language. The message may be presented in various ways including using audible output (e.g., via text-to-speech processing of the message) and/or using visible output of the message (e.g., via a display screen of the conferencing device or some other device that is accessible to the user).

FIG. 3.81 is an example flow diagram of example logic illustrating an example embodiment of process 3.8000 of FIG. 3.80. More particularly, FIG. 3.81 illustrates a process 3.8100 that includes the process 3.8000, wherein the determining speaker-related information includes operations performed by or at the following block(s).

At block 3.8104, the process performs determining the first language. In some embodiments, the process may determine or identify the first language, possibly prior to performing language translation. For example, the process may determine that the one speaker is speaking in German, so that it can configure a speech recognizer to recognize German language utterances.

FIG. 3.82 is an example flow diagram of example logic illustrating an example embodiment of process 3.8100 of FIG. 3.81. More particularly, FIG. 3.82 illustrates a process 3.8200 that includes the process 3.8100, wherein the determining the first language includes operations performed by or at the following block(s).

At block 3.8204, the process performs concurrently processing the received data with multiple speech recognizers that are each configured to recognize speech in a different corresponding language. For example, the process may utilize speech recognizers for German, French, English, Chinese, Spanish, and the like, to attempt to recognize the speaker's utterance.

At block 3.8205, the process performs selecting as the first language the language corresponding to a speech recognizer of the multiple speech recognizers that produces a result that has a higher confidence level than other of the multiple speech recognizers. Typically, a speech recognizer may provide a confidence level corresponding with each recognition result. The process can exploit this confidence level to determine the most likely language being spoken by the one speaker, such as by taking the result with the highest confidence level, if one exists.

FIG. 3.83 is an example flow diagram of example logic illustrating an example embodiment of process 3.8100 of FIG. 3.81. More particularly, FIG. 3.83 illustrates a process 3.8300 that includes the process 3.8100, wherein the determining the first language includes operations performed by or at the following block(s).

At block 3.8304, the process performs identifying signal characteristics in the received data that are correlated with the first language. In some embodiments, the process may exploit signal properties or characteristics that are highly correlated with particular languages. For example, spoken German may include phonemes that are unique to or at least more common in German than in other languages.

FIG. 3.84 is an example flow diagram of example logic illustrating an example embodiment of process 3.8100 of FIG. 3.81. More particularly, FIG. 3.84 illustrates a process 3.8400 that includes the process 3.8100, wherein the determining the first language includes operations performed by or at the following block(s).

At block 3.8404, the process performs receiving an indication of a current location of the user. The current location may be based on a GPS coordinate provided by the conferencing device or some other device. The current location may be determined based on other context information, such as a network identifier, travel documents, or the like.

At block 3.8405, the process performs determining one or more languages that are commonly spoken at the current location. The process may reference a knowledge base or other information that associates locations with common languages.

At block 3.8406, the process performs selecting one of the one or more languages as the first language.

FIG. 3.85 is an example flow diagram of example logic illustrating an example embodiment of process 3.8100 of FIG. 3.81. More particularly, FIG. 3.85 illustrates a process 3.8500 that includes the process 3.8100, wherein the determining the first language includes operations performed by or at the following block(s).

At block 3.8504, the process performs presenting indications of multiple languages to the user. In some embodiments, the process may ask the user to choose the language of the one speaker. For example, the process may not be able to determine the language itself, or the process may have determined multiple equally likely candidate languages. In such circumstances, the process may prompt or otherwise request that the user indicate the language of the one speaker.

At block 3.8505, the process performs receiving from the user an indication of one of the multiple languages. The user may identify the language in various ways, such as via a spoken command, a gesture, a user interface input, or the like.

FIG. 3.86 is an example flow diagram of example logic illustrating an example embodiment of process 3.8100 of FIG. 3.81. More particularly, FIG. 3.86 illustrates a process 3.8600 that includes the process 3.8100 and which further includes operations performed by or at the following block(s).

At block 3.8604, the process performs selecting a speech recognizer configured to recognize speech in the first language. Once the process has determined the language of the one speaker, it may select or configure a speech recognizer or other component (e.g., machine translation engine) to process the first language.

FIG. 3.87 is an example flow diagram of example logic illustrating an example embodiment of process 3.8000 of FIG. 3.80. More particularly, FIG. 3.87 illustrates a process 3.8700 that includes the process 3.8000, wherein the translating an utterance of one of the multiple speakers in a first language into a message in a second language includes operations performed by or at the following block(s).

At block 3.8704, the process performs performing speech recognition, based on the speaker-related information, on the data representing the speech signal to convert the utterance in the first language into text representing the utterance in the first language. The speech recognition process may be improved, augmented, or otherwise adapted based on the speaker-related information. In one example, information about vocabulary frequently used by the one speaker may be used to improve the performance of a speech recognizer.

At block 3.8706, the process performs translating, based on the speaker-related information, the text representing the utterance in the first language into text representing the message in the second language. Translating from a first to a second language may also be improved, augmented, or otherwise adapted based on the speaker-related information. For example, when such a translation includes natural language processing to determine syntactic or semantic information about an utterance, such natural language processing may be improved with information about the one speaker, such as idioms, expressions, or other language constructs frequently employed or otherwise correlated with the one speaker.

FIG. 3.88 is an example flow diagram of example logic illustrating an example embodiment of process 3.8700 of FIG. 3.87. More particularly, FIG. 3.88 illustrates a process 3.8800 that includes the process 3.8700 and which further includes operations performed by or at the following block(s).

At block 3.8804, the process performs performing speech synthesis to convert the text representing the utterance in the second language into audio data representing the message in the second language.

At block 3.8805, the process performs causing the audio data representing the message in the second language to be played to the user. The message may be played, for example, via an audio speaker of the conferencing device.

FIG. 3.89 is an example flow diagram of example logic illustrating an example embodiment of process 3.8700 of FIG. 3.87. More particularly, FIG. 3.89 illustrates a process 3.8900 that includes the process 3.8700, wherein the performing speech recognition includes operations performed by or at the following block(s).

At block 3.8904, the process performs performing speech recognition based on cepstral coefficients that represent the speech signal. In other embodiments, other types of features or information may be also or instead used to perform speech recognition, including language models, dialect models, or the like.

FIG. 3.90 is an example flow diagram of example logic illustrating an example embodiment of process 3.8700 of FIG. 3.87. More particularly, FIG. 3.90 illustrates a process 3.9000 that includes the process 3.8700, wherein the performing speech recognition includes operations performed by or at the following block(s).

At block 3.9004, the process performs performing hidden Markov model-based speech recognition. Other approaches or techniques for speech recognition may include neural networks, stochastic modeling, or the like.

FIG. 3.91 is an example flow diagram of example logic illustrating an example embodiment of process 3.8000 of FIG. 3.80. More particularly, FIG. 3.91 illustrates a process 3.9100 that includes the process 3.8000, wherein the translating an utterance of one of the multiple speakers in a first language into a message in a second language includes operations performed by or at the following block(s).

At block 3.9104, the process performs translating the utterance based on speaker-related information including an identity of the one speaker. The identity of the one speaker may be used in various ways, such as to determine a speaker-specific vocabulary to use during speech recognition, natural language processing, machine translation, or the like.

FIG. 3.92 is an example flow diagram of example logic illustrating an example embodiment of process 3.8000 of FIG. 3.80. More particularly, FIG. 3.92 illustrates a process 3.9200 that includes the process 3.8000, wherein the translating an utterance of one of the multiple speakers in a first language into a message in a second language includes operations performed by or at the following block(s).

At block 3.9204, the process performs translating the utterance based on speaker-related information including a language model that is specific to the one speaker. A speaker-specific language model may include or otherwise identify frequent words or patterns of words (e.g., n-grams) based on prior communications or other information about the one speaker. Such a language model may be based on communications or other information generated by or about the one speaker. Such a language model may be employed in the course of speech recognition, natural language processing, machine translation, or the like. Note that the language model need not be unique to the one speaker, but may instead be specific to a class, type, or group of speakers that includes the one speaker. For example, the language model may be tailored for speakers in a particular industry, from a particular region, or the like.

FIG. 3.93 is an example flow diagram of example logic illustrating an example embodiment of process 3.9200 of FIG. 3.92. More particularly, FIG. 3.93 illustrates a process 3.9300 that includes the process 3.9200, wherein the translating the utterance based on speaker-related information including a language model that is specific to the one speaker includes operations performed by or at the following block(s).

At block 3.9304, the process performs translating the utterance based on a language model that is tailored to a group of people of which the one speaker is a member. As noted, the language model need not be unique to the one speaker. In some embodiments, the language model may be tuned to particular social classes, ethnic groups, countries, languages, or the like with which the one speaker may be associated.

FIG. 3.94 is an example flow diagram of example logic illustrating an example embodiment of process 3.9200 of FIG. 3.92. More particularly, FIG. 3.94 illustrates a process 3.9400 that includes the process 3.9200, wherein the translating the utterance based on speaker-related information including a language model that is specific to the one speaker includes operations performed by or at the following block(s).

At block 3.9404, the process performs generating the language model based on information items generated by the one speaker, the information items including at least one of emails transmitted by the one speaker, documents authored by the one speaker, and/or social network messages transmitted by the one speaker. In some embodiments, the process mines or otherwise processes emails, text messages, voice messages, social network messages, and the like to generate a language model that is specific or otherwise tailored to the one speaker.

FIG. 3.95 is an example flow diagram of example logic illustrating an example embodiment of process 3.8000 of FIG. 3.80. More particularly, FIG. 3.95 illustrates a process 3.9500 that includes the process 3.8000, wherein the translating an utterance of one of the multiple speakers in a first language into a message in a second language includes operations performed by or at the following block(s).

At block 3.9504, the process performs translating the utterance based on speaker-related information including a language model tailored to the voice conference. A language model tailored to the voice conference may include or otherwise identify frequent words or patterns of words (e.g., n-grams) based on prior communications or other information about any one or more of the speakers in the voice conference. Such a language model may be based on communications or other information generated by or about the speakers in the voice conference. Such a language model may be employed in the course of speech recognition, natural language processing, machine translation, or the like.

FIG. 3.96 is an example flow diagram of example logic illustrating an example embodiment of process 3.9500 of FIG. 3.95. More particularly, FIG. 3.96 illustrates a process 3.9600 that includes the process 3.9500, wherein the translating the utterance based on speaker-related information including a language model tailored to the voice conference includes operations performed by or at the following block(s).

At block 3.9604, the process performs generating the language model based on information items by or about any of the multiple speakers, the information items including at least one of emails, documents, and/or social network messages. In some embodiments, the process mines or otherwise processes emails, text messages, voice messages, social network messages, and the like to generate a language model that is tailored to the voice conference.

FIG. 3.97 is an example flow diagram of example logic illustrating an example embodiment of process 3.8000 of FIG. 3.80. More particularly, FIG. 3.97 illustrates a process 3.9700 that includes the process 3.8000, wherein the translating an utterance of one of the multiple speakers in a first language into a message in a second language includes operations performed by or at the following block(s).

At block 3.9704, the process performs translating the utterance based on speaker-related information including a speech model that is tailored to the one speaker. A speech model tailored to the one speaker (e.g., representing properties of the speech signal of the user) may be used to adapt or improve the performance of a speech recognizer. Note that the speech model need not be unique to the one speaker, but may instead be specific to a class, type, or group of speakers that includes the one speaker. For example, the speech model may be tailored for male speakers, female speakers, speakers from a particular country or region (e.g., to account for accents), or the like.

FIG. 3.98 is an example flow diagram of example logic illustrating an example embodiment of process 3.9700 of FIG. 3.97. More particularly, FIG. 3.98 illustrates a process 3.9800 that includes the process 3.9700, wherein the translating the utterance based on speaker-related information including a speech model that is tailored to the one speaker includes operations performed by or at the following block(s).

At block 3.9804, the process performs translating the utterance based on a speech model that is tailored to a group of people of which the one speaker is a member. As noted, the speech model need not be unique to the one speaker. In some embodiments, the speech model may be tuned to particular genders, social classes, ethnic groups, countries, languages, or the like with which the one speaker may be associated.

FIG. 3.99 is an example flow diagram of example logic illustrating an example embodiment of process 3.8000 of FIG. 3.80. More particularly, FIG. 3.99 illustrates a process 3.9900 that includes the process 3.8000, wherein the translating an utterance of one of the multiple speakers in a first language into a message in a second language includes operations performed by or at the following block(s).

At block 3.9904, the process performs translating the utterance based on speaker-related information including an information item that references the one speaker. The information item may include a document, a message, a calendar event, a social networking relation, or the like. Various forms of information items are contemplated, including textual (e.g., emails, text messages, chats), audio (e.g., voice messages), video, or the like. In some embodiments, an information item may include content in multiple forms, such as text and audio, such as when an email includes a voice attachment.

FIG. 3.100 is an example flow diagram of example logic illustrating an example embodiment of process 3.8000 of FIG. 3.80. More particularly, FIG. 3.100 illustrates a process 3.10000 that includes the process 3.8000, wherein the translating an utterance of one of the multiple speakers in a first language into a message in a second language includes operations performed by or at the following block(s).

At block 3.10004, the process performs translating the utterance based on speaker-related information including at least one of a document that references the one speaker, a message that references the one speaker, a calendar event that references the one speaker, an indication of gender of the one speaker, and/or an organization to which the one speaker belongs. A document may be, for example, a report authored by the one speaker. A message may be an email, text message, social network status update or other communication that is sent by the one speaker, sent to the one speaker, or references the one speaker in some other way. A calendar event may represent a past or future event to which the one speaker was invited. An event may be any occurrence that involves or involved the user and/or the one speaker, such as a meeting (e.g., social or professional meeting or gathering) attended by the user and the one speaker, an upcoming deadline (e.g., for a project), or the like. Information about the gender of the one speaker may be used to customize or otherwise adapt a speech or language model that may be used during machine translation. The process may exploit an understanding of an organization to which the one speaker belongs when performing natural language processing on the utterance. For example, the identity of a company that employs the one speaker can be used to determine the meaning of industry-specific vocabulary in the utterance of the one speaker. The organization may include a business, company (e.g., profit or non-profit), group, school, club, team, company, or other formal or informal organization with which the one speaker is affiliated.

FIG. 3.101 is an example flow diagram of example logic illustrating an example embodiment of process 3.100 of FIG. 3.1. More particularly, FIG. 3.101 illustrates a process 3.10100 that includes the process 3.100 and which further includes operations performed by or at the following block(s).

At block 3.10104, the process performs recording history information about the voice conference. In some embodiments, the process may record the voice conference and related information, so that such information can be played back at a later time, such as for reference purposes, for a participant who joins the conference late, or the like.

At block 3.10106, the process performs presenting the history information about the voice conference. Presenting the history information may include playing back audio, displaying a transcript, presenting indications topics of conversation, or the like.

FIG. 3.102 is an example flow diagram of example logic illustrating an example embodiment of process 3.10100 of FIG. 3.101. More particularly, FIG. 3.102 illustrates a process 3.10200 that includes the process 3.10100, wherein the presenting the history information about the voice conference includes operations performed by or at the following block(s).

At block 3.10204, the process performs presenting the history information to a new participant in the voice conference, the new participant having joined the voice conference while the voice conference was already in progress. In some embodiments, the process may play back history information to a late arrival to the voice conference, so that the new participant may catch up with the conversation without needing to interrupt the proceedings.

FIG. 3.103 is an example flow diagram of example logic illustrating an example embodiment of process 3.10100 of FIG. 3.101. More particularly, FIG. 3.103 illustrates a process 3.10300 that includes the process 3.10100, wherein the presenting the history information about the voice conference includes operations performed by or at the following block(s).

At block 3.10304, the process performs presenting the history information to a participant in the voice conference, the participant having rejoined the voice conference after having left the voice conference for a period of time. In some embodiments, the process may play back history information to a participant who leaves and then rejoins the conference, for example when a participant temporarily leaves to visit the restroom, obtain some food, or attend to some other matter.

FIG. 3.104 is an example flow diagram of example logic illustrating an example embodiment of process 3.10100 of FIG. 3.101. More particularly, FIG. 3.104 illustrates a process 3.10400 that includes the process 3.10100, wherein the presenting the history information about the voice conference includes operations performed by or at the following block(s).

At block 3.10404, the process performs presenting at least one of a transcription of utterances made by speakers during the voice conference, indications of topics discussed during the voice conference, and/or indications of information items related to subject matter of the voice conference. The process may present various types of information about the voice conference, including a transcription (e.g., text of what was said and by whom), topics discussed (e.g., based on terms frequently used by speakers during the conference), relevant information items (e.g., emails, documents, plans, agreements mentioned by one or more speakers), or the like.

FIG. 3.105 is an example flow diagram of example logic illustrating an example embodiment of process 3.10100 of FIG. 3.101. More particularly, FIG. 3.105 illustrates a process 3.10500 that includes the process 3.10100, wherein the recording history information about the voice conference includes operations performed by or at the following block(s).

At block 3.10504, the process performs recording the data representing speech signals from the voice conference. The process may record speech, and then use such recordings for later playback, as a source for transcription, or for other purposes.

FIG. 3.106 is an example flow diagram of example logic illustrating an example embodiment of process 3.10100 of FIG. 3.101. More particularly, FIG. 3.106 illustrates a process 3.10600 that includes the process 3.10100, wherein the recording history information about the voice conference includes operations performed by or at the following block(s).

At block 3.10604, the process performs recording a transcription of utterances made by speakers during the voice conference. If the process performs speech recognition as discussed herein, it may record the results of such speech recognition as a transcription of the voice conference.

FIG. 3.107 is an example flow diagram of example logic illustrating an example embodiment of process 3.10100 of FIG. 3.101. More particularly, FIG. 3.107 illustrates a process 3.10700 that includes the process 3.10100, wherein the recording history information about the voice conference includes operations performed by or at the following block(s).

At block 3.10704, the process performs recording indications of topics discussed during the voice conference. Topics of conversation may be identified in various ways. For example, the process may track entities or terms that are commonly mentioned during the course of the voice conference. As another example, the process may attempt to identify agenda items which are typically discussed early in the voice conference. The process may also or instead refer to messages or other information items that are related to the voice conference, such as by analyzing email headers (e.g., subject lines) of email messages sent between participants in the voice conference.

FIG. 3.108 is an example flow diagram of example logic illustrating an example embodiment of process 3.10100 of FIG. 3.101. More particularly, FIG. 3.108 illustrates a process 3.10800 that includes the process 3.10100, wherein the recording history information about the voice conference includes operations performed by or at the following block(s).

At block 3.10804, the process performs recording indications of information items related to subject matter of the voice conference. The process may track information items that are mentioned during the voice conference or otherwise related to participants in the voice conference, such as emails sent between participants in the voice conference.

### 3. Example Computing System Implementation

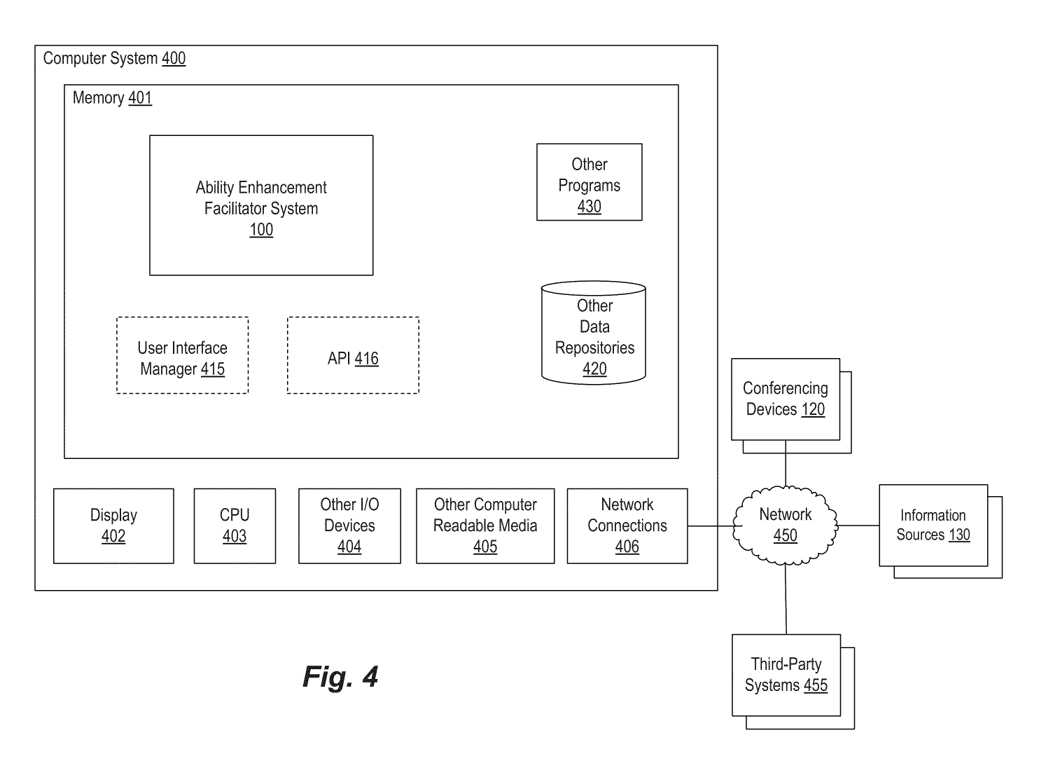

FIG. 4 is an example block diagram of an example computing system for implementing an ability enhancement facilitator system according to an example embodiment. In particular, FIG. 4 shows a computing system 400 that may be utilized to implement an AEFS 100.

Note that one or more general purpose or special purpose computing systems/devices may be used to implement the AEFS 100. In addition, the computing system 400 may comprise one or more distinct computing systems/devices and may span distributed locations. Furthermore, each block shown may represent one or more such blocks as appropriate to a specific embodiment or may be combined with other blocks. Also, the AEFS 100 may be implemented in software, hardware, firmware, or in some combination to achieve the capabilities described herein.

In the embodiment shown, computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. The AEFS 100 is shown residing in memory 401. In other embodiments, some portion of the contents, some or all of the components of the AEFS 100 may be stored on and/or transmitted over the other computer-readable media 405. The components of the AEFS 100 preferably execute on one or more CPUs 403 and facilitate ability enhancement, as described herein. Other code or programs 430 (e.g., an administrative interface, a Web server, and the like) and potentially other data repositories, such as data repository 420, also reside in the memory 401, and preferably execute on one or more CPUs 403. Of note, one or more of the components in FIG. 4 may not be present in any specific implementation. For example, some embodiments may not provide other computer readable media 405 or a display 402.

The AEFS 100 interacts via the network 450 with conferencing devices 120, speaker-related information sources 130, and third-party systems/applications 455. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems/applications 455 may include any systems that provide data to, or utilize data from, the AEFS 100, including Web browsers, e-commerce sites, calendar applications, email systems, social networking services, and the like.

The AEFS 100 is shown executing in the memory 401 of the computing system 400. Also included in the memory are a user interface manager 415 and an application program interface (“API”) 416. The user interface manager 415 and the API 416 are drawn in dashed lines to indicate that in other embodiments, functions performed by one or more of these components may be performed externally to the AEFS 100.

The UI manager 415 provides a view and a controller that facilitate user interaction with the AEFS 100 and its various components. For example, the UI manager 415 may provide interactive access to the AEFS 100, such that users can configure the operation of the AEFS 100, such as by providing the AEFS 100 credentials to access various sources of speaker-related information, including social networking services, email systems, document stores, or the like. In some embodiments, access to the functionality of the Ul manager 415 may be provided via a Web server, possibly executing as one of the other programs 430. In such embodiments, a user operating a Web browser executing on one of the third-party systems 455 can interact with the AEFS 100 via the UI manager 415.

The API 416 provides programmatic access to one or more functions of the AEFS 100. For example, the API 416 may provide a programmatic interface to one or more functions of the AEFS 100 that may be invoked by one of the other programs 430 or some other module. In this manner, the API 416 facilitates the development of third-party software, such as user interfaces, plug-ins, adapters (e.g., for integrating functions of the AEFS 100 into Web applications), and the like.

In addition, the API 416 may be in at least some embodiments invoked or otherwise accessed via remote entities, such as code executing on one of the conferencing devices 120, information sources 130, and/or one of the third-party systems/applications 455, to access various functions of the AEFS 100. For example, an information source 130 may push speaker-related information (e.g., emails, documents, calendar events) to the AEFS 100 via the API 416. The API 416 may also be configured to provide management widgets (e.g., code modules) that can be integrated into the third-party applications 455 and that are configured to interact with the AEFS 100 to make at least some of the described functionality available within the context of other applications (e.g., mobile apps).

In an example embodiment, components/modules of the AEFS 100 are implemented using standard programming techniques. For example, the AEFS 100 may be implemented as a “native” executable running on the CPU 403, along with one or more static or dynamic libraries. In other embodiments, the AEFS 100 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the AEFS 100, such as in the data store 420 (or 240), can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 420 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the AEFS 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of this disclosure. For example, the methods, techniques, and systems for ability enhancement are applicable to other architectures or in other settings. For example, instead of providing assistance to users who are engaged in face-to-face conversation, at least some of the techniques may be employed in remote communication, such as telephony systems (e.g., POTS, Voice Over IP, conference calls), online voice chat systems, and the like. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A method for ability enhancement, the method comprising:
receiving data representing speech signals from a voice conference amongst multiple speakers, wherein the multiple speakers include at least three speakers;
determining speaker-related information associated with each of the multiple speakers, based on the data representing speech signals from the voice conference; and
presenting the speaker-related information via a conferencing device associated with a user.

2. The method of claim 1, wherein the receiving data representing speech signals from a voice conference amongst multiple speakers includes: receiving data representing speech signals from a voice conference amongst multiple speakers, wherein the multiple speakers are remotely located from one another.

3. The method of claim 1, wherein the presenting the speaker-related information includes: as each of the multiple speakers takes a turn speaking during the voice conference, presenting speaker-related information associated with the speaker.

4. The method of claim 3, wherein the receiving data representing speech signals from a voice conference amongst multiple speakers includes: in response to one of the speakers beginning to speak during the voice conference, presenting the speaker-related information associated with the speaker.

5. The method of claim 1, wherein the presenting the speaker-related information includes: presenting the speaker-related information during a telephone conference call amongst the multiple speakers.

6. The method of claim 1, further comprising: presenting, while a current speaker is speaking, speaker-related information on a display device of the user, the displayed speaker-related information identifying the current speaker.

7. The method of claim 1, wherein the receiving data representing speech signals from a voice conference amongst multiple speakers includes: receiving audio data from a telephone conference call that includes the multiple speakers, the received audio data representing utterances made by at least one of the multiple speakers.

8. The method of claim 1, wherein the receiving data representing speech signals from a voice conference amongst multiple speakers includes: receiving audio data from an online audio chat that includes the multiple speakers, the received audio data representing utterances made by at least one of the multiple speakers.

9. The method of claim 1, wherein the receiving data representing speech signals from a voice conference amongst multiple speakers includes: receiving audio data from a video conference that includes the multiple speakers, the received audio data representing utterances made by at least one of the multiple speakers.

10. The method of claim 1, wherein the receiving data representing speech signals from a voice conference amongst multiple speakers includes: receiving data representing speech signals from the at least three speakers, the data obtained at the conferencing device.

11. The method of claim 1, further comprising: determining which one of the multiple speakers is speaking during a time interval.

12. The method of claim 11, wherein the determining which one of the multiple speakers is speaking during a time interval includes: associating a first portion of the received data with a first one of the multiple speakers.

13. The method of claim 12, wherein the associating a first portion of the received data with a first one of the multiple speakers includes: receiving the first portion of the received data along with an identifier associated with the first speaker.

14. The method of claim 13, wherein the receiving the first portion of the received data along with an identifier associated with the first speaker includes: receiving a network identifier associated with the first speaker.

15. The method of claim 13, wherein the receiving the first portion of the received data along with an identifier associated with the first speaker includes: receiving from a conferencing system the identifier associated with the first speaker, the conferencing system configured to facilitate a conference call among the multiple speakers.

16. The method of claim 12, wherein the associating a first portion of the received data with a first one of the multiple speakers includes: selecting the first portion based on the first portion representing only speech from the one speaker and no other of the multiple speakers.

17. The method of claim 11, further comprising: determining that two or more of the multiple speakers are speaking concurrently.

18. The method of claim 11, wherein the determining which one of the multiple speakers is speaking during a time interval includes: performing voice identification to select which one of multiple previously analyzed voices is a best match for the one speaker who is speaking during the time interval.

19. The method of claim 11, wherein the determining which one of the multiple speakers is speaking during a time interval includes: performing voice identification based on the received data to identify one of the multiple speakers.

20. The method of claim 19, wherein the performing voice identification includes: comparing properties of the speech signal with properties of previously recorded speech signals from multiple persons.

21. (canceled)

22. The method of claim 19, wherein the performing voice identification includes: processing telephone voice messages stored by a voice mail service.

23. The method of claim 11, wherein the determining which one of the multiple speakers is speaking during a time interval includes:
performing speech recognition to convert the received data into text data; and
identifying one of the multiple speakers based on the text data.

24. The method of claim 23, wherein the identifying one of the multiple speakers based on the text data includes: finding an information item that references the one speaker and that includes one or more words in the text data.

25. (canceled)

26. (canceled)

27. The method of claim 23, further comprising:
retrieving information items that reference the text data; and
informing the user of the retrieved information items.

28. The method of claim 23, wherein the performing speech recognition includes: performing speech recognition based at least in part on a language model associated with the one speaker, wherein the language model is based on information items generated by the one speaker, the information items including at least one of emails transmitted by the one speaker, documents authored by the one speaker, and/or social network messages transmitted by the one speaker.

29. (canceled)

30. (canceled)

31. The method of claim 11, further comprising:
receiving data representing a speech signal that represents an utterance of the user; and
identifying one of the multiple speakers based on the data representing a speech signal that represents an utterance of the user, by determining whether the utterance of the user includes a name of the one speaker.

32-38. (canceled)

39. The method of claim 11, further comprising:
developing a corpus of speaker data by recording speech from multiple persons; and
identifying one of the multiple speakers based at least in part on the corpus of speaker data.

40. (canceled)

41. (canceled)

42. The method of claim 1, wherein the presenting the speaker-related information includes: presenting the speaker-related information on a display of the conferencing device.

43. The method of claim 1, wherein the presenting the speaker-related information includes: presenting the speaker-related information on a display of a computing device that is distinct from the conferencing device.

44. The method of claim 1, wherein the presenting the speaker-related information includes: determining a display to serve as a presentation device for the speaker-related information, selecting one display from multiple displays, based at least in part on whether each of the multiple displays is capable of displaying all of the speaker-related information.

45-47. (canceled)

48. The method of claim 1, further comprising: audibly notifying the user to view the speaker-related information on a display device.

49. The method of claim 1, wherein the presenting the speaker-related information includes: informing the user of an identifier of each of the multiple speakers.

50. (canceled)

51. (canceled)

52. The method of claim 1, wherein the presenting the speaker-related information includes: informing the user of a previously transmitted communication referencing one of the multiple speakers.

53. (canceled)

54. The method of claim 1, wherein the presenting the speaker-related information includes: informing the user of an event involving the user and one of the multiple speakers.

55. (canceled)

56. The method of claim 1, wherein the determining speaker-related information includes: accessing information items associated with one of the multiple speakers.

57-60. (canceled)

61. The method of claim 1, wherein the presenting the speaker-related information includes: transmitting the speaker-related information from a first device to a second device having a display.

62-66. (canceled)

67. The method of claim 1, further comprising: performing the receiving data representing speech signals from a voice conference amongst multiple speakers, the determining speaker-related information, and/or the presenting the speaker-related information on a mobile device that is operated by the user.

68. (canceled)

69. (canceled)

70. The method of claim 1, further comprising: determining to perform at least some of determining speaker-related information or presenting the speaker-related information on another computing device that has available processing capacity.

71-79. (canceled)

80. The method of claim 1, further comprising:
translating an utterance of one of the multiple speakers in a first language into a message in a second language, based on the speaker-related information; and
presenting the message in the second language.

81-100. (canceled)

101. The method of claim 1, further comprising:
recording history information about the voice conference; and
presenting the history information about the voice conference.

102. The method of claim 101, wherein the presenting the history information about the voice conference includes: presenting the history information to a new participant in the voice conference, the new participant having joined the voice conference while the voice conference was already in progress.

103. The method of claim 101, wherein the presenting the history information about the voice conference includes: presenting the history information to a participant in the voice conference, the participant having rejoined the voice conference after having left the voice conference for a period of time.

104. The method of claim 101, wherein the presenting the history information about the voice conference includes: presenting at least one of a transcription of utterances made by speakers during the voice conference, indications of topics discussed during the voice conference, and/or indications of information items related to subject matter of the voice conference.

105. The method of claim 101, wherein the recording history information about the voice conference includes: recording the data representing speech signals from the voice conference.

106. The method of claim 101, wherein the recording history information about the voice conference includes: recording a transcription of utterances made by speakers during the voice conference.

107. The method of claim 101, wherein the recording history information about the voice conference includes: recording indications of topics discussed during the voice conference.

108. The method of claim 101, wherein the recording history information about the voice conference includes: recording indications of information items related to subject matter of the voice conference.

109-324. (canceled)
